(19) United States
(12) Patent Application Publication
(10) Pub. No.: US 2025/0202012 A1
(43) Pub. Date: Jun. 19, 2025

(54) MONOCOQUE VEHICLE, STRUCTURED BATTERY AND METHOD OF MANUFACTURE

(71) Applicant: The Structural Battery Company Ltd., St. Neots (GB)

(72) Inventors: Oliver Burstall, St. Neots (GB); John Moffat, St. Neots (GB)

(21) Appl. No.: 18/848,050

(22) PCT Filed: Mar. 17, 2023
(86) PCT No.: PCT/GB2023/050656

§ 371 Date: Sep. 17, 2024

(30) Foreign Application Priority Data
Mar. 18, 2022 (GB) 2203825.1
Jan. 26, 2023 (GB) 2301156.2

(51) Int. Cl. H01M 50/249; B60R 16/033; B60R 16/04; B62D 23/00; B62D 65/02; H01M 10/613; H01M 10/625; H01M 10/643; H01M 10/6554; H01M 10/6556; H01M 10/6568; H01M 50/213; H01M 50/264; H01M 50/503; H01M 50/512

(52) U.S. Cl. CPC H01M 50/249; B60R 16/033; B60R 16/04; B62D 23/00; B62D 65/02; H01M 10/613; H01M 10/625; H01M 10/643; H01M 10/6554; H01M 10/6556; H01M 10/6568; H01M 50/213; H01M 50/264; H01M 50/503; H01M 50/512; H01M 2220/20

(57) ABSTRACT

The present invention relates to a vehicle comprising a body having first and second layers that form at least part of a monocoque structure; a battery comprising cylindrical cells held together by a bonding material in a hexagonal pattern in a same plane, bonding a surface of a cell to an adjacent surface of an adjacent cell with triangular gaps between the cells, wherein the battery is located between the first and second layers; and connecting means for mechanically fixing the battery to the first and second layers.

### TECHNICAL FIELD

The present disclosure relates generally to electric batteries, and more particularly, to structures of electric batteries, methods of manufacturing said structures, and how these electric batteries may serve structural purposes.

### INTRODUCTION

Electric vehicles are becoming more commonplace and accessible in daily life, particularly electric cars, and even within motorsports.

Most powered vehicles were developed and designed with an internal combustion engine (ICE) to provide power to the vehicle for the purpose of transportation. This holds true for automobiles, aircrafts, and watercrafts. Of course, a battery was also employed within such vehicles to provide power for auxiliary purposes.

The typical design of an electric vehicle has two approaches: 1) simply replace the ICE internals with electric equivalents. This may mean replacing the ICE and fuel tanks with batteries, transformers, electric motors, and the like. It is also typical to keep the design of electric vehicles, specifically electric cars, as similar to the ICE version as possible; 2) use an electric vehicle skateboard and place the coachwork on the skateboard. This is a similar approach to the use of the ladder chassis seen with, for example, Land Rover (RTM).

There is need to minimize the weight of a vehicle without compromising strength and rigidity. Extra weight typically necessitates additional body or chassis reinforcement, which further adds to weight. Batteries also take up more space than corresponding engine and fuel tank components in an ICE vehicle, which in turn means a larger, heavier vehicle or less passenger and luggage/payload space.

There is a need for an improved design for batteries and in particular batteries for vehicles.

### SUMMARY OF THE INVENTION

A structural sandwich panel battery is provided that comprises cylindrical cells held together by a bonding material in a hexagonal pattern in the same plane, bonding a surface of a cell to an adjacent surface of an adjacent cell with triangular gaps between the cells for fluid flow in an axial direction between the cells.

The cylindrical cells are preferably, but not essentially oriented in the same polarization.

The sandwich panel layers are used mechanically for strength and stiffness and electrically to evacuate the energy.

Preferably, the cylindrical cells are fixed to a layered structure and are oriented perpendicular to a layer of the structure.

Preferably, the cylindrical cells are fixed to a layered structure and are oriented parallel to a layer of the structure.

Preferably, the non-conductive bonding material is applied along a line of contact of adjacent cylindrical cells.

Preferably, each cylindrical cell is connected to a bus bar.

Preferably, the positive terminal of each cylindrical cell is connected to the bus bar via a fuse.

Preferably, each cylindrical cell has its positive terminal electrically insulated from all neighboring cylindrical cell terminals other than via the bus bar.

Preferably, the cylindrical cells are held within a cuboidal container.

Preferably, the cylindrical cells are orientated in alternating polarization.

A vehicle is also provided comprising: a body having first and second layers that form at least part of a monocoque structure; a battery as described and claimed, located between the first and second layers and connecting means for mechanically fixing the battery to the first and second layers.

Preferably, one of the first and second layers is an outer skin of the vehicle.

Preferably, the battery has a positive terminal and a negative terminal and the negative terminal is electrically connected to the outer skin.

The vehicle may be an automobile, motorbike, scooter, e-mobility platform, watercraft, submarine, eVTOL, helicopter or aircraft.

The cells of the battery may be aligned perpendicular to the first and second layers or parallel thereto. Both arrangements are described herein.

The battery is preferably fixedly connected to the both first and second layers.

In this way, the battery imparts rigidity to the vehicle. It provides strength and rigidity to the monocoque structure. By virtue of the triangular gaps or voids between the cells, the overall rigidity is increased without unnecessarily adding to weight. The batteries add no more weigh that is necessary to provide the ampere hours and voltage needed for the particular vehicle, but in the new arrangement, they add to the structural rigidity of the vehicle. In other words, they allow for weight saving by replacing other components that would otherwise be required for structural purposes.

Alternatively, the advantage of the arrangement can be viewed as minimizing space required to provide batteries for a monocoque vehicle.

The cylindrical cells may be held within a cuboidal container that is mechanically fixed to the vehicle body (e.g. by epoxy resin and/or reinforcing fiber or by a suitable surrounding flange that is glued/welded/bolted or otherwise rigidly fixed to the vehicle body.

The battery may perform the function of an elongate beam structure.

A method of manufacture of a battery is also provided, comprising providing a plurality of cylindrical cells; and bonding surfaces of the cells to adjacent surfaces of adjacent cells in a hexagonal pattern in a same plane, with triangular gaps between the cells.

Preferably, the cell surfaces are bonded with a single line of bonding material along a line of contact of adjacent cells.

A method of manufacturing a vehicle comprising manufacturing a battery as described above is further provided, wherein manufacturing a vehicle comprising a body having first and second layers that form at least part of a monocoque structure comprises placing the battery between the first and second layers; and mechanically fixing the battery to the first and second layers via connecting means.

Preferably, the connecting means is one of welding, gluing, bolting and riveting.

In accordance with a further aspect of the invention, a battery is provided that comprises a plurality of cylindrical cells held together by a bonding material in a hexagonal pattern in a same plane, bonding a surface of a cell to an adjacent surface of an adjacent cell with triangular gaps formed there between, and wherein a first end of each cylindrical cell of the battery is connected to a first electrical end plate to electrically connect the plurality of cylindrical cells in parallel. At least one channel is provided to direct coolant flow across the first electrical end plate to cool the first end of each cylindrical cell of the battery.

The provided battery may further have a first coolant end plate adjacent to the first electrical end plate, the at least one channel being formed in the first coolant end plate. Also it may have a first electrically insulating membrane sandwiched between the first electrical end plate and the first coolant end plate.

The at least one channel of the battery is configured to create turbulent flow of coolant therein. For example, the at least one channel has at least one sharp edge. Alternatively, the at least one channel has a zigzag form. The coolant used may be a non-conductive fluid. For example, the coolant may be a dielectric oil or de-ionised water.

The battery provided may also be configured such that a second end of each cylindrical cell of the battery is connected to a second electrical end plate. The battery provided may also have at least one channel is provided to direct coolant flow across the second electrical end plate to cool the second end of each cylindrical cell of the battery. The battery provided may also have a second coolant end plate adjacent to the second electrical end plate, the at least one channel being formed in the second coolant end plate

A first and a second water-proof layer either side of the at least one channel respectively may be provided in the battery. The first and a second water-proof layer are both configured to prevent coolant flowing through the triangular gaps formed between the adjacent cells.

In accordance with another aspect of the invention a battery pack is provided. The battery pack comprises a first battery in combination with a second battery. Each of the batteries in the battery pack may be a battery in accordance with the aspect of the invention outlined above. In addition, the battery pack may further comprise an interface plate to connect the at least one channel provided to direct coolant flow across the first electrical end plate of the first battery with the at least one channel provided to direct coolant flow across the first electrical end plate of the second battery, wherein the interface plate comprises at least one fluid path for the flow of coolant between the first and second battery respectively.

The at least one fluid path in the interface plate of the battery pack may have a first end in fluid communication with the at least one channel of the first battery, and a second end in fluid communication with the at least one channel of the second battery.

The interface plate may connect the at least one channel to direct coolant flow across the first electrical end plate of the first battery with the at least one channel to direct coolant flow across the first electrical end plate of the second battery.

In accordance with this aspect of the invention the battery may also be provided with a second interface plate to connect at least one channel provided to direct coolant flow across the second electrical end plate of the first battery with the at least one channel provided to direct coolant flow across the second electrical end plate of the second battery, wherein the second interface plate comprises at least one fluid path for the flow of coolant between the first and second battery respectively. As with the first interface plate, the at least one fluid path of the second interface plate may have a first end in fluid communication with the at least one channel of the first battery, and a second end in fluid communication with the at least one channel of the second

In accordance with a further aspect of the invention a battery cooling system may be provided. The battery cooling system comprises at least one battery pack according to the aspect of the invention outlined above. The battery cooling system may further have a radiator configured to extract heat from the coolant, a second fluid pathway to direct coolant from the at least one battery pack to the radiator, a third fluid pathway to direct coolant from the radiator back into the at least one battery pack, and a pump to pump the coolant from the radiator back into the battery pack.

In accordance with a yet further aspect of the invention a battery is provided. The battery may have a plurality of cylindrical cells in a hexagonal pattern in a same plane, wherein a first end of each cylindrical cell of the battery is connected to an electrical end plate to electrically connect the plurality of cylindrical cells in parallel. Each cylindrical cell of the battery connects to the electrical end plate at a corresponding electrical connection point. Each electrical connection point comprises a central portion for connection with the terminal of a cylindrical cell and at least one fuse arm extending between the central portion and the electrical connection point.

The at least one fuse arm may be a continuous spiral fuse arm extending between the central portion and the electrical connection point. Each electrical connection point may comprise at least two fuse arms extending between the central portion and the electrical connection point. The fuse arms may be circumferentially arranged around the electrical connection point. Each fuse arm may be is thinner than the outer edge of the electrical connection point. Each fuse arm may be formed by etching.

According to a method of manufacturing the battery of any of the aspects of the invention discussed above may comprise providing a plurality of elongate pipes alongside a plurality of cylindrical cells in a hexagonal pattern, wherein a length of each elongate pipe extends along a length of the cylindrical cell, and wherein each elongate pipe comprises a plurality of openings along a length of the elongate pipe adjacent to the outer surface of the cylindrical cell, injecting, through an opening at an end of each elongate pipe, a bonding substance such that the bonding substance flows along the length of each elongate pipe and out of the openings along the length of each elongate pipe.

The bonding substance may be injected through the opening at the end of each elongate pipe under pressure. The bonding substance may be an epoxy resin.

The method of manufacturing of the battery may further comprise arranging, adjacent to a first end of each cylindrical cell of the battery, a first electrical end plate to electrically connect the plurality of cylindrical cells in parallel, and wherein at least one channel is provided to direct coolant flow across the first electrical end plate to cool the first end of each cylindrical cell of the battery.

The method of manufacturing of the battery may further comprise arranging, adjacent to a second end of each cylindrical cell of the battery, a second electrical end plate, and electrically connecting a terminal of each cylindrical cell to a corresponding electrical connection point on the second electrical end plate, each electrical connection point comprising a central portion for connection with the terminal of the cylindrical cell and at least two fuse arms extending between the central portion and an outer edge of the electrical connection point.

The terminal of each cylindrical cell may be electrically connected to the corresponding electrical connection point on the second electrical end plate by either ultrasonic welding and/or conductive adhesive.

The method of manufacturing of the battery may further comprise arranging, adjacent to an end of a first end of each cylindrical cell of the battery a first water-proof layer, arranging, adjacent to a first water-proof layer, a first electrical end plate to electrically connect the plurality of cylindrical cells in parallel, and wherein at least one channel is provided to direct coolant flow across the first electrical end plate to cool the first end of each cylindrical cell of the battery, and arranging, adjacent to first electrical end plate a second water-proof layer so as to sandwich the first electrical end plate between two water-proof layers.

The method of manufacturing of the battery may further comprise arranging, adjacent to the first electrical end plate, a first coolant end plate adjacent to the first electrical end plate, the first coolant end plate having the at least one channel to direct coolant flow across the first coolant end plate to cool the first end of each cylindrical cell of the battery.

The method of manufacturing of the battery may further comprise arranging, adjacent to the first electrical end plate, a first water-proof layer, arranging, adjacent to the first water-proof layer, a first coolant end plate adjacent to the first electrical end plate, the first coolant end plate having the at least one channel to direct coolant flow across the first coolant end plate to cool the first end of each cylindrical cell of the battery, and arranging, adjacent to first coolant end plate a second water-proof layer so as to sandwich the first coolant end plate between two water-proof layers.

The method of manufacturing of the battery may further comprise arranging an electrically insulating membrane between the first coolant end plate and the first electrical end plate.

Other optional and advantageous features will be described with reference to the accompanying drawings. The drawings and corresponding descriptions are provided by way of example only.

### BRIEF DESCRIPTION OF THE DRAWINGS

FIG. 1 illustrates part of a vehicle including a monocoque and a frame.

FIG. 2 further illustrates the monocoque of FIG. 1 in exploded view.

FIG. 3 illustrates a redesigned rear bulkhead that is an alternative to that of FIGS. 1 and 2.

FIG. 4 illustrates a cross sectional view of the rear bulkhead

FIG. 5 illustrates an exploded view of a battery formed from a plurality of cylindrical cells.

FIG. 6 illustrates a top down view of the battery, with bonding material along lines of contact between adjacent cells.

FIG. 7 illustrates a side on view of the battery

FIG. 8 illustrates a top down view of the battery in an arrangement alternative to that of FIG. 6.

FIG. 9 illustrates a cross section of a boat, showing spaces where a battery may be positioned.

FIG. 10 illustrates a cross section of an aircraft wing, showing a battery in position.

FIG. 11 illustrates a cross section of an aircraft cabin, with various batteries.

FIG. 12 illustrates the internal construction of a cell of FIG. 5

FIG. 13 illustrates a group of cells in a “horizontal” orientation between two layers.

FIG. 14 illustrates an alternative arrangement for the base of the battery 500a shown in FIG. 5.

FIG. 15 illustrates a triangular support structure used to manufacture the battery.

FIG. 16 illustrates a hexagonally arranged set of cells that form a battery using triangular support structures.

FIG. 17 illustrates an electrical end plate with a plurality of fuses for connection to the battery.

FIG. 18a illustrates a cross-sectional view of one of the fuses for connection to the battery shown in FIG. 17. FIG. 18b shows another cross-sectional view A-A of said fuse.

FIG. 19a illustrates a cross-sectional view of an alternative electrical end plate with a plurality of fuses for connection to the battery. FIG. 19b illustrates one of the fuses for connection to the battery shown in FIG. 19a. FIG. 19c shows another cross-sectional view B-B of said fuse.

FIG. 20 illustrates a channel for turbulent fluid flow across one of the terminals of the cells of the battery.

FIG. 21 illustrates a means of connecting multiple batteries of cylindrical cells into a multi-battery pack.

FIG. 22 illustrates a battery pack system.

FIG. 23 illustrates a flow diagram of a method of manufacturing a battery.

FIG. 24 illustrates a flow diagram of a method of operating the battery pack system of FIG. 22.

FIG. 25 illustrates a first example of a cuboidal container.

FIG. 26a & FIG. 26b illustrate an alternative container.

### DETAILED DESCRIPTION

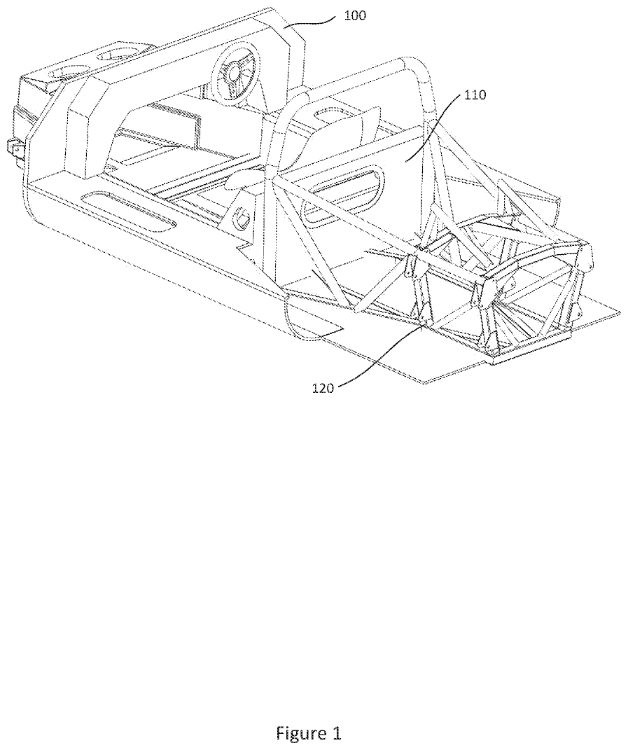

FIG. 1 illustrates an example body of a vehicle including a monocoque structure 100, rear bulkhead 110, and a frame 120 which may be referred to as a subframe or spaceframe. In particular, the rear bulkhead 110 serves as an interface between the monocoque 100 and frame 120 in that the bulkhead is connected to the monocoque or integrally formed with the monocoque and the frame is connected (e.g. bolted) to the bulkhead. Other arrangements can be envisaged that are entirely monocoque and have no frame. The monocoque is formed from composite material such as carbon fiber reinforced resin (e.g. carbon fiber but alternatively glass fiber).

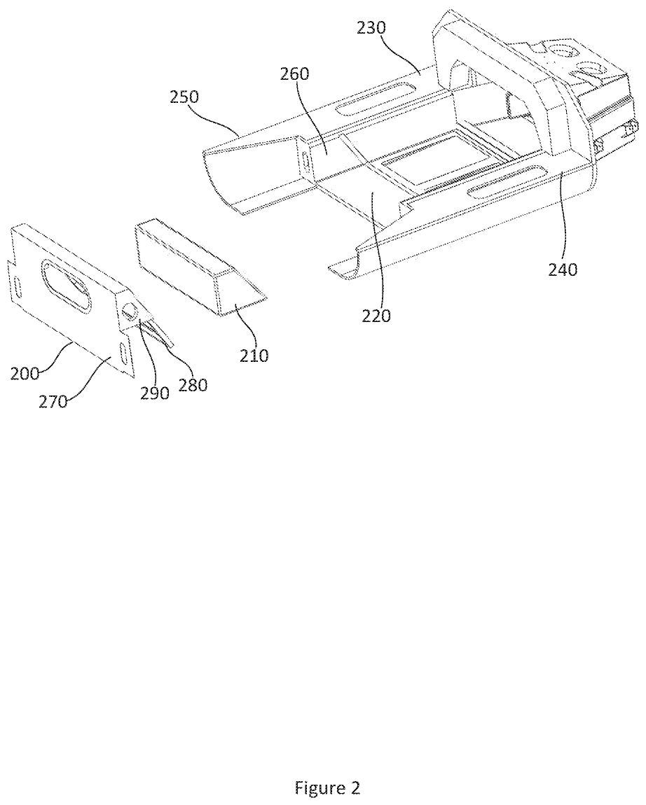

FIG. 2 shows that the monocoque 100 comprises a rear part 200 and a front part 220. Inside the rear part 200 is a fuel tank 210. The front part 220 has side parts 230 and 240 extending along the left and right sides of the vehicle. Each side part is a sandwich panel constructed of inner and outer layers, with filler material there between, such as a lightweight foam or honeycomb material. For example, left side part 230 has an outer layer 250 which forms the skin of the vehicle and an inner layer 260. Such a two-layer structure provided rigidity to the monocoque. The layers are integrally formed from the same fiber reinforced material, and the two-layer structure provides rigidity against bending and shearing as well as protection against compression forces that might cause the panels to buckle.

The rear bulkhead 200 encloses and protects the fuel tank 210. The rear bulkhead 200 provides structural support against bending (in x, y and z directions) and against shear. The rear bulkhead 200 has front and rear (fore and aft) layers 270, 280, which are connected by left and right side panels 290. Together, these give the bulkhead rigidity to protect the fuel tank 210.

FIG. 2 illustrates an exploded view of an example of a vehicle including a monocoque structure. In some embodiments, it comprises a rear part 200 (rear bulkhead 200) and a front part 220. Inside the rear part 200 is a fuel tank 210. The front part 220 has side parts 230 and 240 extending along the left and right sides of the vehicle. Each side part is a sandwich panel constructed of inner and outer layers. For example, left side part 230 has an outer layer 250 which forms the skin of the vehicle and an inner layer 260. Such a two-layer structure provides rigidity to the monocoque. The monocoque is formed from composite material such as carbon fiber reinforced resin (e.g. carbon fiber but alternatively glass fiber). The layers may be integrally formed from the same fiber reinforced material (or from different composites), and the two-layer structure provides rigidity against bending and shearing as well as protection against compression forces that might cause the panels to buckle. Filler material may be added between the layers, such as a lightweight foam or honeycomb material. It may be injected into gaps between the layers and allowed to set or harden, adhering to the inner and outer layers and adding to the rigidity. The rear bulkhead 200 encloses and protects the fuel tank 210. The rear bulkhead 200 provides structural support against bending (in x, y and z directions) and against shear. The rear bulkhead 200 has front and rear (fore and aft) layers 270, 280, which are connected by left and right side panels 290. Together, these give the bulkhead rigidity to protect the fuel tank 210.

A frame, subframe or spaceframe (not shown) may be connected to the rear bulkhead 200. The frame may be connected (e.g. bolted) to the bulkhead. Other arrangements can be envisaged that are entirely monocoque and have no frame.

The vehicle may be an automobile, submarine, electric vertical take-off and landing (eVTOL) vehicle, helicopter or aircraft. Alternatively it may be a motorbike, scooter, e-mobility platform or watercraft. As another example we may consider a monocoque fuselage of a helicopter or eVTOL craft. In such case, it may have a nose, a tail, a forward floor panel, a mid-floor panel and a rear floor panel. It may have upper ribs and lower ribs and a reinforcing rib integral to one of the floor panels. All the aforesaid elements may be integrally constructed as a monocoque structure.

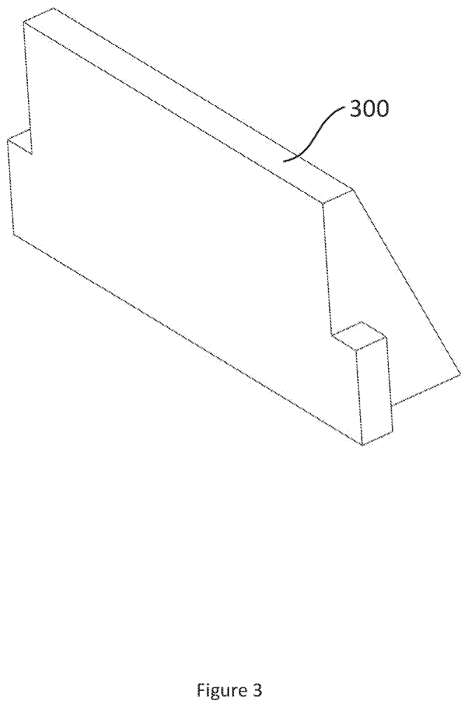

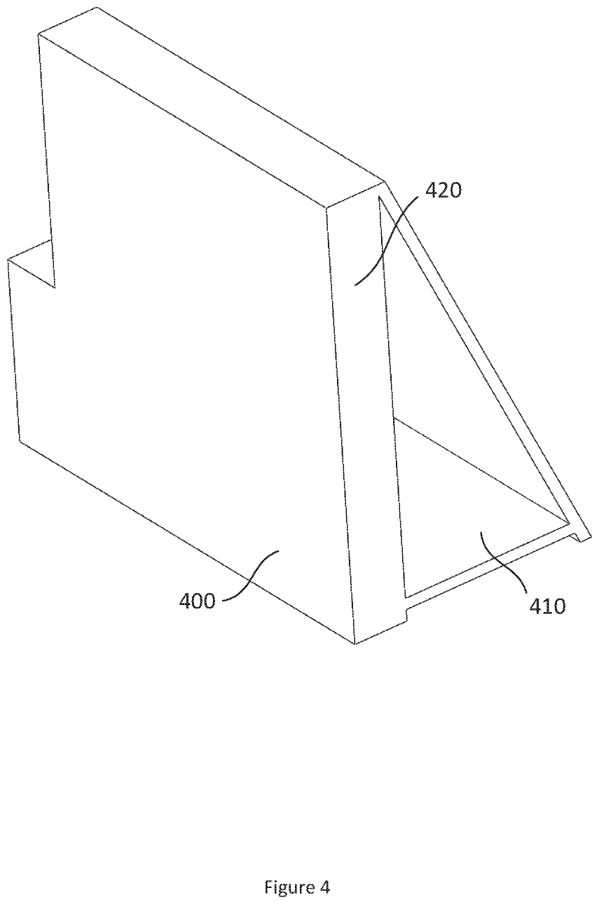

Referring to FIG. 3 and FIG. 4, in particular the hollow space 410 or solid space 420 would be areas of interest for containing batteries contributing to the overall rigidity and structural integrity of the Eagle Plate 300.

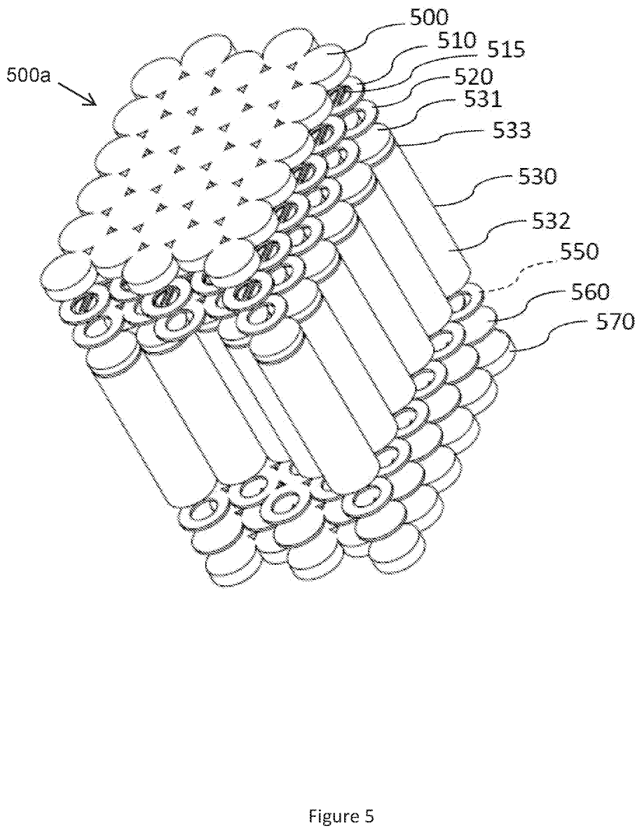

FIG. 5 displays a plurality of cylindrical cells 530, in an exploded view, arranged in a hexagonal pattern, with bus bars 510, 560, and insulation 500, 520, 550, 570 vertically above and below. Insulation 520 is formed of a continuous web of circular discs, each with a central hole. Insulator 550 is similar but optional. Each cylindrical cell 530 has a positive terminal 531 at one end, nominally the top, and the rest of the body (including the opposite end to the positive terminal 531, nominally the bottom) is a metal cylinder with no external insulation and therefore acts as a negative terminal 532. The cylindrical cell 530 has a built-in insulator 533 to separate the upper negatively charged rim/shoulder of the cell 532 from the positive ‘button top’ terminal 531

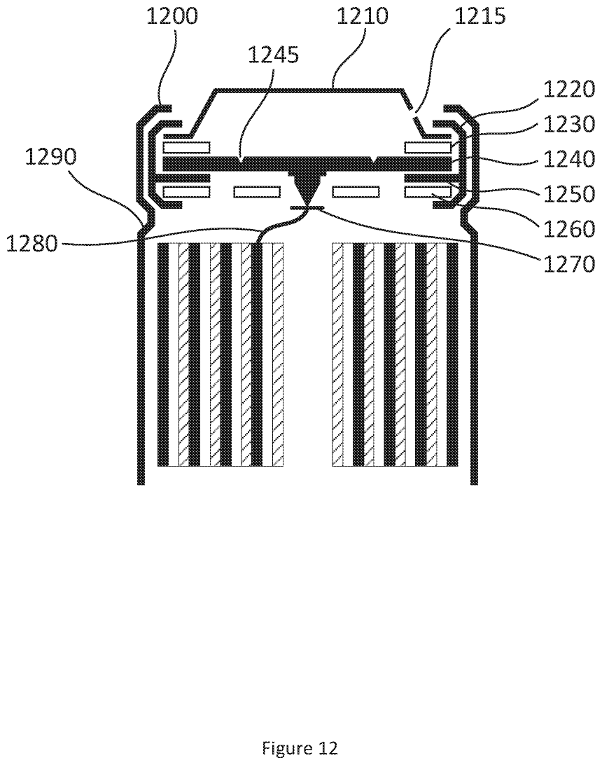

Each of the positive terminals 531 of the cylindrical cells 530 has an upwardly protruding ‘button top’ (shown in FIG. 12) that is internally insulated from the rim of the respective cell and is externally insulated by insulation 520 from directly touching the positive terminal bus bar 510. This latter insulation 520 is to prevent the bus bar having direct contact with any cylindrical cell 530. Insulation 520 also prevents the possibility that a positive terminal 531 of one cylindrical cell 530 may touch the negative terminal 532 of a neighboring cylindrical cell 530 due to misalignment.

The positive terminal bus bar 510 connects to each positive terminal 531 via a respective fuse 515 that goes through the respective hole in insulation 520. This fuse 515 ensures that any fault of a cylindrical cell 530 becomes isolated and does not affect any other cylindrical cells 530 or any surrounding system connected to the battery.

The negative terminal 532 may be connected through an insulation layer 550 to a negative terminal bus bar 560. The insulation layer 550 may also not be present, in which case the negative terminal 532 is directly connected to a negative terminal bus bar 560. The insulation layer 550 is presented for symmetry purposes in ease of manufacturing a plurality of batteries in opposing orientations.

The positive terminal bus bar 510 and negative terminal bus bar 560 have insulating caps 500 and 570 respectively. These serve the purpose of electrically insulating the bus bars 510 and 560 from any surrounding system or structure. In the case of the negative terminal bus bar, the cap is optional, as it is often the case that the negative terminal is grounded direct to an external skin of a vehicle.

The arrangement of cylindrical cells shown in FIG. 5 forms a battery or can form several batteries with suitable connectors to connect them in series. This arrangement could also be extended in any radial direction with respect to the cylindrical cells 530.

Insulation layer 550, if present, allows for a simple busbar construction in the case of serially connecting groups of cells. It maintains symmetry top and bottom of the cell so that the same construction extends across cells that are to be connected in series. Where insulation 550 is present, alternative connections are required to connect the negative ends of the cells to the lower busbar, similar to the connections used to connect the positive terminals.

In some embodiments, FIG. 5 depicts an exploded view of a battery 500a formed from a plurality of cylindrical cells arranged in a hexagonal pattern. Each cell has a cylindrical cross section and is an electrochemical cell. For example each cell may be a voltaic or galvanic cell which generates an electric current, alternatively each cell may be electrolytic cells which generate chemical reactions via electrolysis. Each cell has a body 530 containing the cell chemistry. Each cell of the battery has a respective first end which is connected to a first electrical end plate 510 to electrically connect the plurality of cells in parallel.

The end plate 510 functions as, and may be considered to be, a “bus bar”, but that term will be reserved herein to refer to other electrical connectors that may connect one battery of cells to another battery of cells and be designed to conduct even higher current than the electrical end plate.

There is insulation 520, 500, 550, 570 above/below the respective first end of each cell, and above/below the first electrical end plate. The insulation 520; 570 above/below the first electrical end plate may be formed of a continuous web of circular discs, each with a central hole. Insulation 550 may be similar to insulation 520; 570 but is optional. Each cylindrical cell has a positive terminal 531 at one end, nominally the top, and the rest of the body 530 (including the opposite end to the positive terminal, nominally the bottom) is a metal cylinder with no external insulation and therefore acts as a negative terminal. The cylindrical cell 530 may also have a built-in insulator 533 to separate the upper negatively charged rim/shoulder of the cell from the positive ‘button top’ terminal.

Each of the positive terminals of the cylindrical cells 530 has an upwardly protruding ‘button top’ (not shown) that is internally insulated from the rim of the respective cell and is externally insulated by insulation 520 from directly touching the first electrical end plate 510 to prevent the first electrical end plate having direct contact with any cell i.e. the first electrical end plate 510 may be a positive electrical end plate. Insulation 520 also prevents the possibility that a positive terminal of one cylindrical cell may touch the negative terminal of a neighboring cylindrical cell due to misalignment.

The first electrical end plate 510 connects to each positive terminal 531 via a respective fuse (not shown, described later) that goes through a hole in insulation 520. This fuse ensures that any fault of a cylindrical cell 530 becomes isolated and does not affect any other cylindrical cells or any surrounding system connected to the battery.

The negative terminal may be connected through an insulation layer 550 to a second electrical end plate 560 i.e. the second electrical end plate 560 may be a negative electrical end plate. The insulation layer 550 may not be present, in which case the negative terminals directly connected to second electrical end plate 560. The insulation layer 550 is presented for symmetry purposes in ease of manufacturing a plurality of batteries in opposing orientations.

The first electrical end plate 230 and second electrical end plate 560 may have insulating caps 500 and 570 respectively. These serve the purpose of electrically insulating the electrical end plates from any surrounding system or structure. In the case of one of the electrical end plates being a negative electrical end plate, the cap is optional, as it is often the case that the negative terminal is grounded direct to an external skin of the place where the battery is stored e.g. a vehicle.

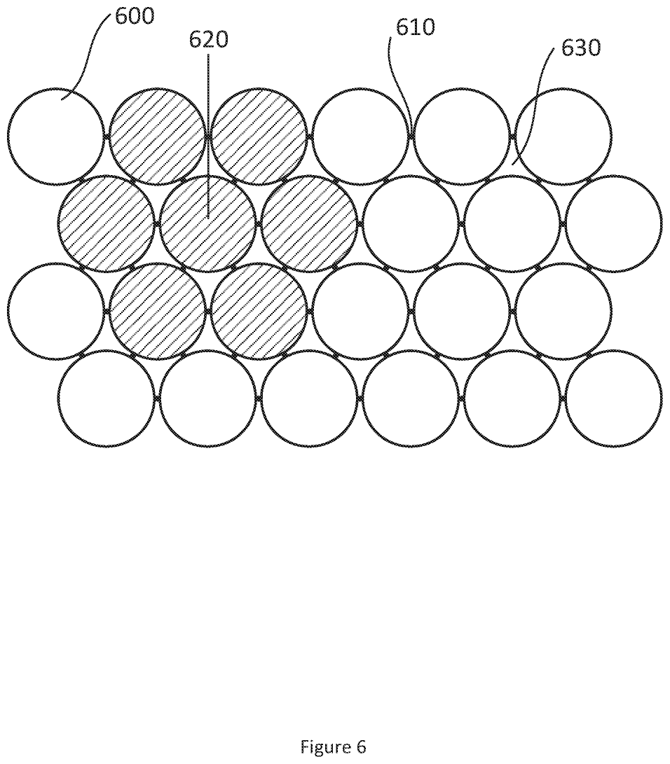

FIG. 6 illustrates a top down view of cylindrical cells 600 joined with a bonding material 610 along the line of contact where cylindrical cells would touch when arranged in a hexagonal pattern in a same plane. Seven of the cells in a hexagon pattern are shown cross-hatched for example and further explanation. Four rows of cells are shown, but there may be more or fewer.

The bonding material between the cells can be electrically conductive, but is preferably non-conductive. It is structural, in the sense that it adds rigidity to the overall structure. It is preferably epoxy resin.

Every three neighboring cells 600 create a triangular gap 630 between them. Broadly speaking the shape of the gap 630 is a hyperbolic triangle, as this triangular gap 630 is between three curved surfaces, but bonding material would be found at each vertex of the triangular gap 630.

This triangular gap 630 provides for a lightweight structure as will be described. It can also facilitate the expansion of the cells when charging together with the circulation of coolant around the cells 600, and consequently around the entire battery. The coolant may be air that is allowed to flow by convection or by forced convection due to movement of the vehicle and slipstream channeled into the batteries. Alternatively, it may be pumped air or other pumped cooling fluid.

The coolant may either be circulated directly through these triangular gaps 630, or through pipes that pass through the triangular gaps 630.

By whatever means the coolant circulates through the triangular gaps 630, the coolant also has space to pass above and below the cells. This allows for the coolant to pass both vertically through the triangular gaps 630, and across the tops and bottoms of the cells 600 within the battery.

The busbars 510 and 560 may serve as cooling plates to the batteries.

The electrical insulating layer 500, 520, 550 and 570 may be used as channels for cooling fluid.

When a cell in isolation is subjected to end-to-end axial compression, it eventually fails by buckling outwards to form a barrel shape. Joining cylindrical cells 600 along the line of contact provides an increased axial compressive load bearing capability compared to the axial compressive load bearing capability of a single cell. I.e. for the seven cells shown cross-hatched, the center cell 620 is supported on six sides by other cells that prevent cell 620 from buckling outward. For cylindrical cells 600 bonded as in FIG. 6, the overall compressive load bearing capability would be higher than the sum of the load bearing capability of all the individual cylindrical cells 600.

Batteries may be connected in parallel or series arrangements as is possible for all batteries.

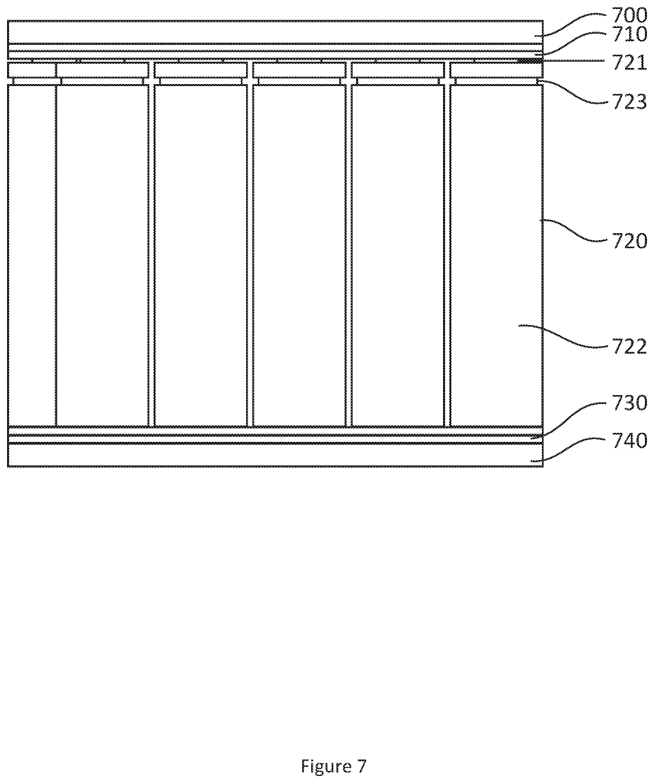

FIG. 7 illustrates a side on view of the hexagonal arrangement of a plurality of cylindrical cells 720 as described above referring to FIG. 5.

Each cylindrical cell 720 has a positive terminal 721 and negative terminal 722, and an indent 723. In the view shown in FIG. 7, the part of the cylindrical cell 720 above the indent 723 is part of the positive terminal 721, and the part of the cylindrical cell below the indent 723 is part of the negative terminal 722.

The positive terminal 721 interfaces with the upper layer 710, which comprises insulation 520 and bus bar 510, which in turn is covered by an insulating cap 700.

The negative terminal 722 interfaces with the lower layer 730, which comprises insulation 550 and bus bar 560, which in turn is covered by an insulating cap 740.

Each of these layers serves the same purposes as described above in reference to FIG. 5.

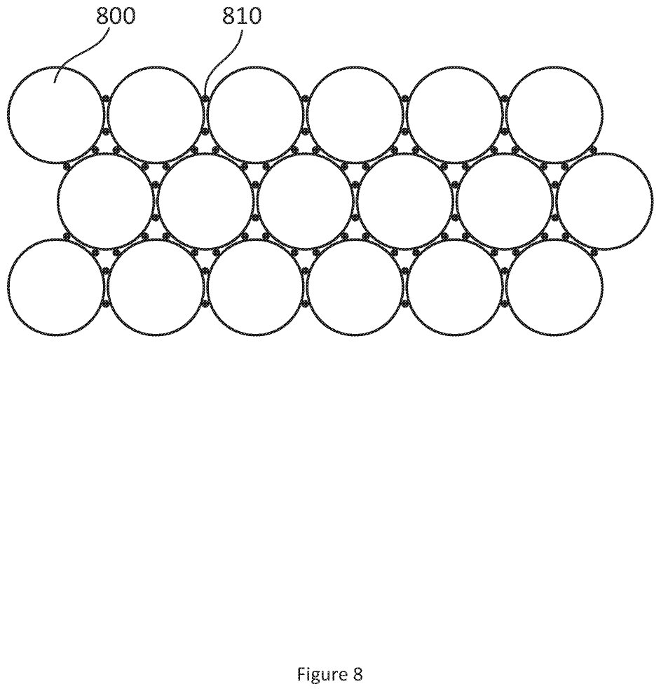

FIG. 8 illustrates a top down view of cylindrical cells 800 joined with a bonding material 810 along a line on either side of and parallel to the line of contact where the cylindrical cells touch when arranged in a hexagonal pattern in a same plane. Three rows of cells are shown, but there may be more or fewer.

This alternative arrangement of bonding material 810 provides a lower axial compressive load bearing capability compared to the axial compressive load bearing capability of the arrangement of FIG. 6, and also less than the sum of the individual cylindrical cells. The reason the arrangement of FIG. 6 is preferred is because there is a leverage effect between the point of contact of two cells and the point of bonding. A sideways or shear force on the cells of FIG. 8 causes two cells to roll against each other. This rolling can pull apart the bond if the bond is not at the point of contact. It may also be noted that the arrangement of FIG. 8 requires more bonding material. Nevertheless, the arrangement of FIG. 8 may have other advantages such as ease of manufacture. It can be manufactured by first placing cells side-by-side and then applying a line of bonding material (rather than applying the material and then placing the cells together).

The hexagonal pattern of FIG. 8 varies from that shown in FIG. 6 in that the amount of bonding material 810 is greater. For example, while in FIG. 6 each cell is bonded via bonding material 610 located at 3 different points along the length of the cell, in FIG. 8, each cell may be bonded to adjacent cells by using bonding material 810 at up to 12 different points along the length of the cell. Advantageously, by increasing a number of bonding points between cells improves the rigidity of the structure and makes the hexagonal pattern more stable.

Other arrangements may be preferred, for example in which each row of cells is bonded as shown in FIG. 8 but rows are placed together side-by-side (or laid horizontally and mounted on top of each other) and bonded as shown in FIG. 6.

The cells as arranged in FIG. 6 or 8 may not necessarily all be in the same orientation. The simplest arrangement of cells is to have all cells within the battery in parallel, as this allows for a simple construction and bus bar. The cells may be arranged such that some cells within the battery are in opposite orientation to other cells. E.g., a row or block of cells within the battery may be in one orientation and connected in series with another row or block in an opposite orientation. Such an arrangement of cells requires separated bus bar sections and does not excessively complicate the construction and bus bar.

When containing cells 600 within a battery container, the container is preferably cuboidal in shape, but any shape that fit all the cells 600 would suffice. The outermost cells 600 of the battery are preferably rigidly fixed to the inside of the battery container. This fixing can be done with a similar bonding material to bonding material 610 used to bond cells 600 together, or any other bonding material.

The battery container should thus be similar in size to the battery in order to facilitate a rigid fixing of the battery to the battery container. The size of the battery container should also take into account the coolant system (if any), and may allow for some extra room both above and below the battery.

There may be grooves, channels or other textures in the lid and/or floor of the battery container to direct coolant flow across the top of the battery, through the triangular gaps between the cells and through similar channels or other features across the bottom of the battery to be returned to a radiator for cooling and/or a pump for recirculating. Alternatively, there may be continuous pipes running up and down each row of gaps between cells, the pipes originating and separating from an inlet manifold and re-joining at an outlet manifold. Alternatively, the lid may serve as a manifold for pipes passing between the cells and the floor may serve as another manifold. The battery container may also have holes that allow for coolant to flow, either directly or through pipes, in and out of the battery and battery container.

The battery container also requires fixing to external structures, such as a monocoque or other vehicle body. This fixing may be a bonding material similar to that used for bonding cells together. The fixing may also be a more mechanical fixing, such as attaching the battery container via screws or bolts to any structure. Any mechanical fixing may also include brackets, or welding, or other fixing means.

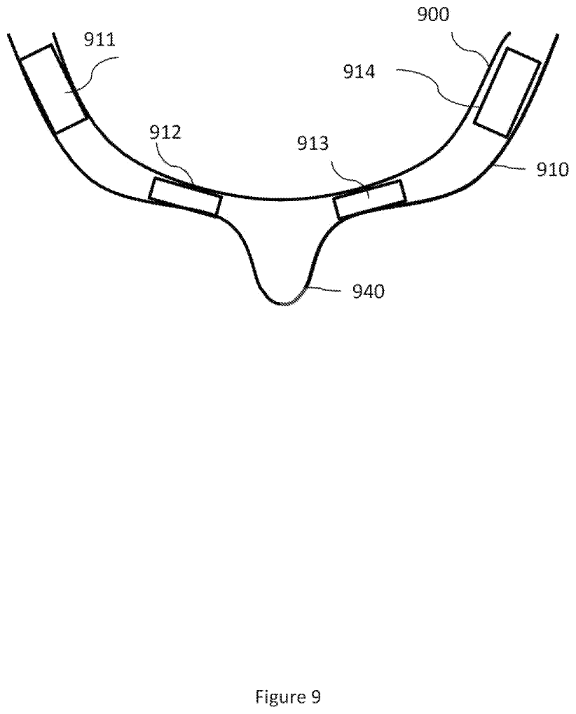

FIG. 9 illustrates a cross section of the hull of a boat, watercraft, or ship. This hull has an inner layer 900 and outer layer 910. The space between these layers may contain batteries as previously described.

The cells of the batteries may be located in a radial direction, i.e. with the axial dimension of the cells mounted normal to the hull, i.e. “vertically” with inner and outer busbars attached on the positive and negative terminals. However, the cells can be arranged “horizontally”. In this arrangement, the cells lie parallel to the inner and outer layers 900 and 910 (the sandwich layer is placed radially on the cell) and each busbar extends in an annulus around the vehicle. This configuration works very well for circular or curved requirements such as aircraft hulls. Indeed, the individual cells are more resistive to radial compression than axial compression and, with adhesive between them to stop them rolling against each other, the construction is very strong.

Suitable locations for the batteries are 911, 912, 913 and 914. Batteries in these positions contribute to/increase the overall rigidity and structural integrity of the boat. Lower positions 912 and 913, close to the keel 930, are preferred for stability, but other locations 911 and 914 may be preferred for protection against impact forces in areas that may be vulnerable to collision. Batteries of equal weight are preferably positioned in pairs on port and starboard sides, at equal distance from the centerline of the boat.

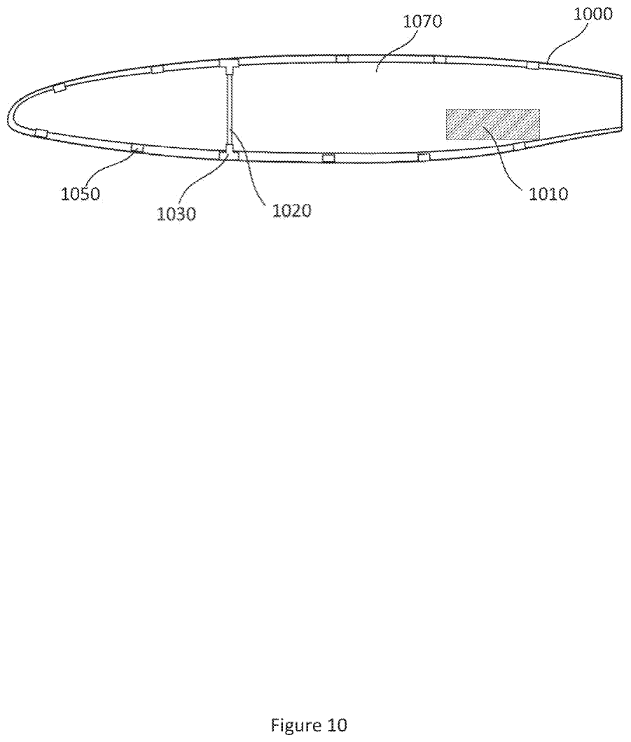

FIG. 10 illustrates a cross section of an aerofoil or wing 1000. It has a spar web 1020, a spar cap 1030, a number of left-to-right stringers 1050 and a number of fore-and-aft transverse ribs 1070. A space 1010 inside the aerofoil or wing may be used as space for batteries. The batteries may run substantially most of the length along an aircraft wing, from the fuselage (not shown) to almost the tip (not shown), In this way, the batteries can serve as a beam to contribute to the overall rigidity and structural integrity of the wing.

With such batteries, other internal reinforcing structures can be omitted. For example, there may be stringers forward and rearward of the batteries but none in the vicinity of the batteries. Equally, there need not be a web where the batteries extend. Alternatively, the batteries could be placed further forward in the position of web 1020 and web foot 1030 and these components may be omitted.

In this way structural components are replaced by batteries, which also serve the same structural purpose as the structure replaced.

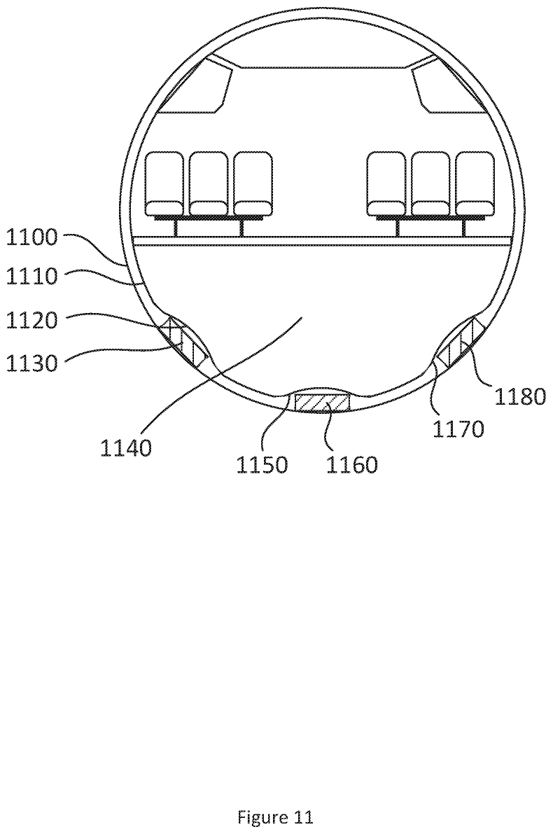

FIG. 11 illustrates an aircraft cabin cross section. The cabin has an outer skin 1100, and inner skin 1110. Three locations have been illustrated as places for batteries between the inner skin 1110 and outer skin 1100. These are shown by batteries 1130, 1160, and 1180.

To account for the possibility that these batteries 1130, 1160, and 1180 may be larger than the current space between inner skin 1100 and outer skin 1110, a bulge in the inner skin 1100 has also been illustrated by 1120, 1150, and 1170.

The space 1140 is typically used for luggage, and may have other various structures filling the space. Batteries may also be used to contribute to the overall rigidity and structural integrity of any structures in this space, as well as to the cabin.

If the cells are placed in the “horizontal” orientations, there may be no need for any bulges. The cells can fit in the space between the inner and outer skins of the fuselage.

As another example we may consider a monocoque fuselage of a helicopter or eVTOL craft. It may have a nose, a tail, a forward floor panel, a mid floor panel and a rear floor panel. It may have upper ribs and lower ribs. A reinforcing rib may also be present and integral to the rear floor panel. This is optional, as will be explained. All the aforesaid elements are integrally constructed as a monocoque structure.

There may be large holes left and right for doors, a large hole at the front for a windscreen and other holes near the tail for smaller windows or access panels.

Each of the floor panels may be constructed of inner and outer layers (skins) with filler material therebetween. The filler material may have voids throughout. The entire construction is strong and lightweight and has good crash resistance.

The reinforcing rib may be used as a location for batteries. Alternatively, where the batteries are located between the layers of the monocoque structure, the rib may be unnecessary.

The batteries are preferably located in the floor behind (rearward of) the occupants (pilot, co-pilot, passenger) and/or beneath the occupants.

Batteries as described with reference to FIGS. 5-8.

FIG. 12 illustrates a portion of a cylindrical cell (e.g. 530, 720) including the positive terminal. This portion of a cylindrical cell has an outer casing 1200 (also the negative terminal), a positive terminal contact 1210, a vent 1215, plastic inserts 1220 and 1250, a top disk 1240, scoring in the top disk 1245, a bottom disk 1260, a metallic foil 1270, a tab 1280, an indent 1290, and a thermal fuse 1230 between the top disc 1240 and the positive terminal 1210.

The outer casing 1200 serves as a negative terminal. The positive terminal contact 1210 connects to the positive terminal of the cell through the thermal fuse 1230, top disk 1240, and tab 1280. The vent 1215 in the positive terminal contact 1210 prevents the pressure between the positive terminal contact 1210 and the internals of the battery from rising much higher than the pressure external to the positive terminal contact 1210, thus preventing any explosions.

The scoring in the top disk 1240 encourages a certain failure mode of the battery in the case of the internals expanding due to heat or other causes. The plastic inserts 1220 serves to insulate the positive terminal contact 1210 from the negative terminal 1200, and plastic insert 1250 serves to insulate the top disk 1240 from the bottom disk 1260. The indent 1290 in the outer casing 1200 crimps the layers 1210-1260 together.

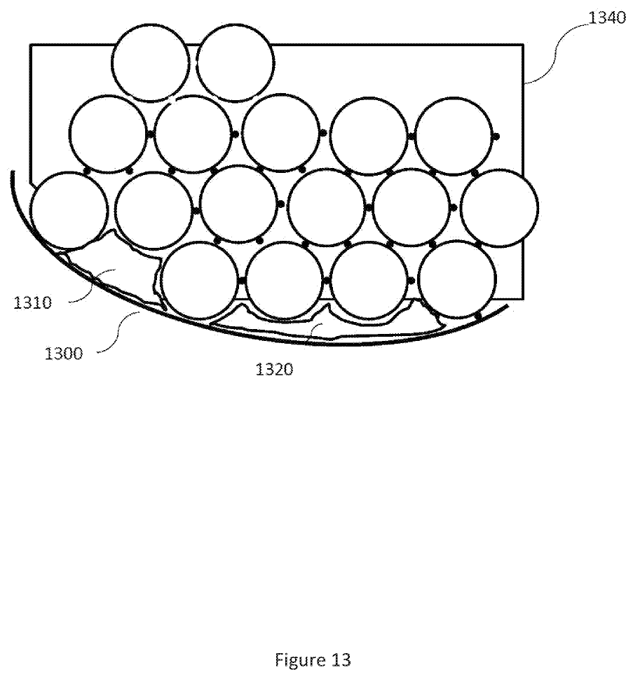

Referring to FIG. 13, a group of cells similar to those described with reference to FIG. 6 (or FIG. 8) are shown in their “horizontal” orientation, that is to say, they lie parallel to a layer of a monocoque structure, for example an outer skin 1300. Between the skin and the cells are bonding material 1310 and 1320′, that bond the cells to the skin. A similar arrangement is provided for an inner skin.

A busbar 1340 lies along each of the terminals of the cells. Only one such busbar is shown, for example contacting the negative terminals but it will be understood that another busbar or similar connections are provided for the positive terminals. The busbar may be curved to match the curve of the monocoque structure.

FIG. 13 illustrates how cells in this orientation can follow the contour or the skin 1400 of a monocoque structure and bonding material hold the outermost layer or row in place so that inner layers that are bonded to the outer layer are also help rigidity. In the same way, there is bonding material across an innermost layer of cells bonding to an inner skin of the monocoque structure.

Although the arrangement of FIG. 13 is shown in relation to an outer layer or skin, it can be applied to an inner layer only or to both inner and outer layers.

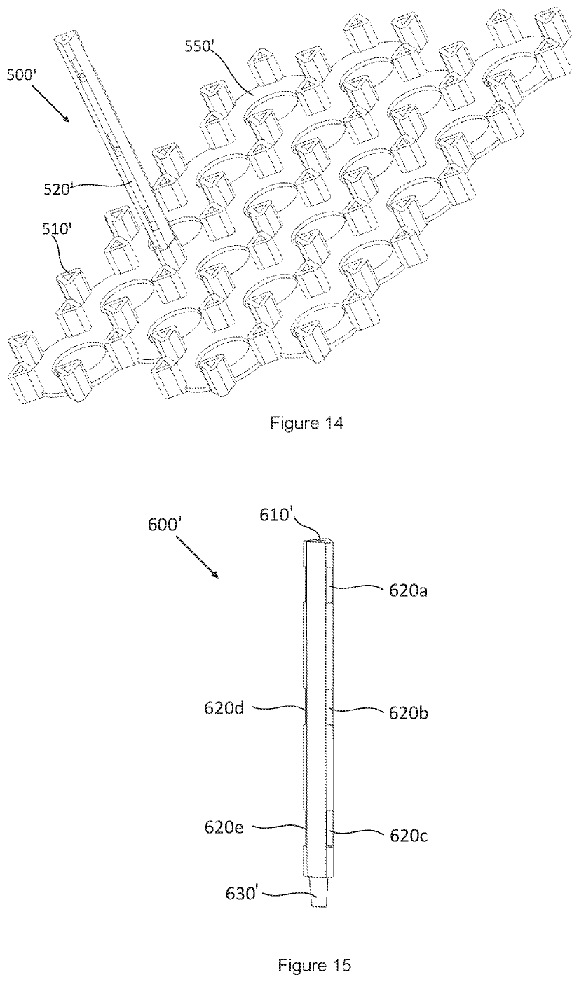

FIG. 14 depicts an alternative arrangement for the base of the battery 500a shown in FIG. 5. It shows battery 500 with insulator rings 550′ (which correspond to the insulators 550 in FIG. 5). Each insulator ring 550′ depicted corresponds to a location of a cell of the battery. Twenty insulator rings 550′ are depicted, corresponding to twenty cells in a hexagon pattern. Four rows of cells are shown, but there may be more or fewer. Between each insulator ring 550′ of the battery there are triangular holders 510′ (between three and six depending on the location in the pattern). Each of these triangular holders 510′ may be integrally molded with the insulators. Other forms of connection may also be possible. Other shapes of holder may also be possible. Such holders are optional according to the method of manufacture of the battery.

Triangular support structures 520′ (also referred to as elongate pipes), are inserted into the triangular holders 510′. Each support structure has a length close to or the same as the length of a cylindrical cell of the battery. Triangular holders 510′ are optional. In the absence of holders, the insulator rings 550′ may be attached directly to an outer surface of a cell of the battery.

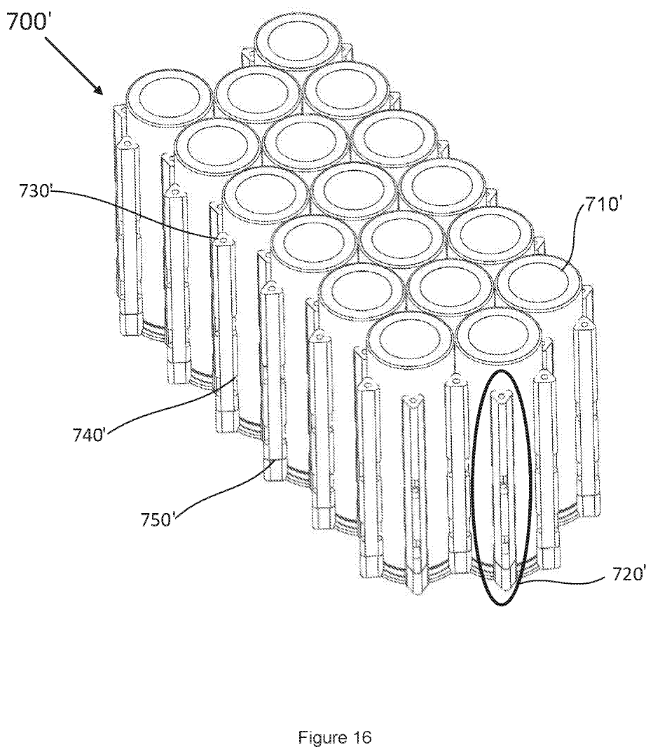

FIG. 15 depicts one of the triangular support structures 600′ (also referred to as an elongate pipe). The triangular support structure has a plurality of openings/holes 620a-e along the length of the structure. The openings/holes are arranged along each corner of the triangle. Each opening/hole is configured so as to allow bonding material to ooze out of the openings/holes, under pressure or under gravity, to come into contact with cells arrange on each side of the triangular support structure. The number of holes/openings shown in FIG. 15 is given for example only. The number of holes/openings may vary. Each triangular support structure is also provided with a top opening 610′ at the top of the structure, through which bonding material can be fed, preferably under pressure. Additionally and/or alternatively, the bottom of the support structure can also have an opening (not shown) through which bonding material can be fed under pressure. Optionally, the bottom of the support structure may also comprise an insertion piece 630′ for use when triangular holder 510′ as shown in FIG. 14 is used. As previously indicated, the cross-section of the support structure may not be triangular, for example it may be circular. In such case the openings/holes may be arranged around the circumference of the support structure.

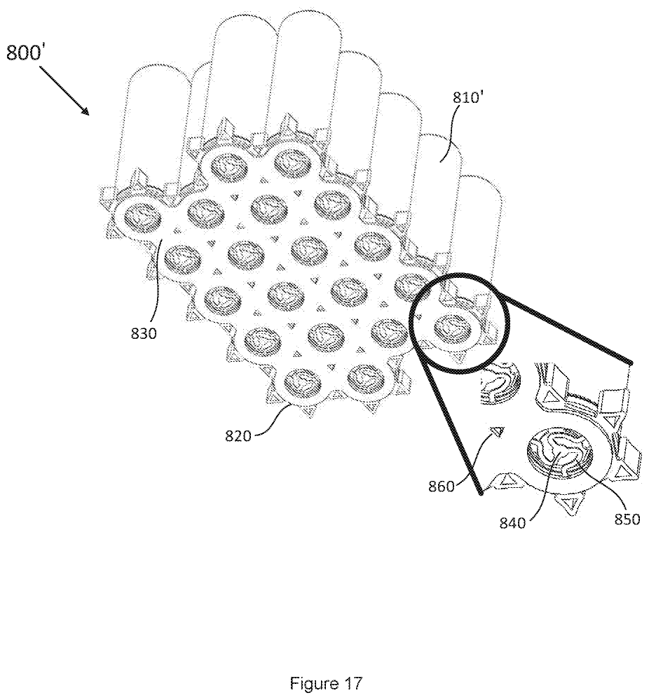

FIG. 16 depicts a hexagonally arranged set of cells 710′ that form a battery. Depicted are a total of eighteen cells 710′ arranged hexagonally into a battery comprising three rows. Those cells are depicted with the negative terminal at the top of each cell. Although not shown, mounted on top of the negative terminals of the cells, there may be a first electrical end plate (also referred to as a negative end plate).

The number of cells and rows in a battery may be more or fewer than depicted.

Between and on the surfaces of the cells of the battery there is shown a number of triangular support structures 720′. These correspond to the triangular support structures shown in FIG. 15. Only those adjacent the outermost cells are visible in FIG. 16. Triangular support structures 720′ of one cell come into abutment with the outer surface of an adjacent cell in the battery. Each of those triangular support structures 720′ has at least one opening 730′ at the top of the structure through which bonding material can be fed under pressure or gravity. Alternatively or in addition, another opening (not shown) may be provided at the bottom of the structure through which bonding material can be fed under pressure. Each triangular support structure 720′ also comprises a number of holes/openings 740′ along the length of the support structure through which bonding material can seep/pass when it is fed through the opening 730′. Optionally (as is shown in FIG. 16), in between cells of the battery there is also a number of triangular holders 750′ into which the triangular support structures 720′ are inserted.

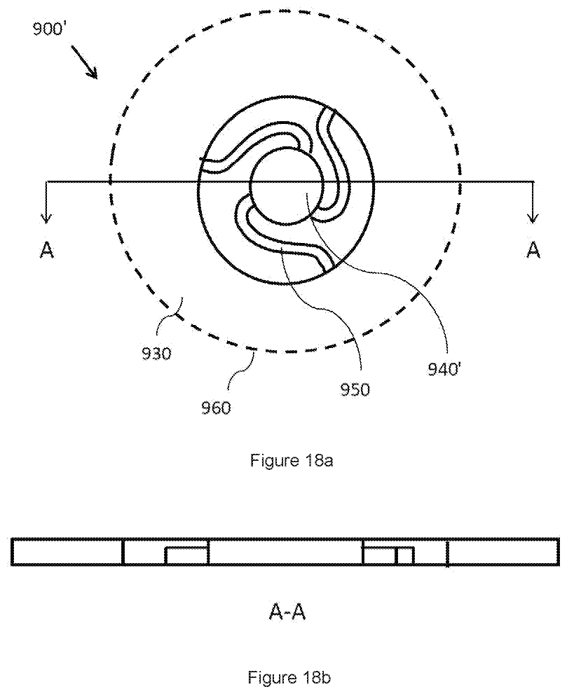

FIG. 17 depicts an under-surface of the battery, with the positive terminal of each cell 810′ being located on the underside of the battery. In particular, FIG. 17 depicts the array of cells when formed in the hexagonal pattern discussed with respect to FIGS. 14 & 16. At the base/under-surface of the battery, there is a second electrical end plate (also referred to as a positive end plate). Optionally, (as is shown in FIG. 17) in between cells of the battery, there are a number of triangular holders 820 into which the triangular support structures shown in FIGS. 15 & 16 are inserted.

The second electrical end plate 830 may be a solid continuous plate comprising a plurality of fuses, each of those fuses being attached to a corresponding one of the positive terminals of a cell. The fuses on the second electrical end plate may also be referred to as electrical connection points of the second electrical end plate.

Each fuse which forms each electrical connection point may have a central portion 840 for connection with a positive terminal of a cell. The central portion may be held in place by at least one, but preferably two or three fuse arms 850 that extend between the central portion and an outer edge of the electrical connection point. In the example of FIG. 17, three such fuse arms are shown. Below, an example of one fuse arm is also described.

The fuse arms may be straight fuse arms that extend in a straight line between the central portion and an outer edge of the electrical connection point. Alternatively, the fuse arms 850 may be spiral fuse arms with a generally spiral shape/configuration. Further still, the fuse arms may have an arc shape. Other shapes of the fuse arms are also envisaged. Any number of fuse arms may be provided circumferentially around the central portion of the fuse. At least two fuse arms are provided and preferably at least three fuse arms are provided.

By providing the at least two fuse arms 850 between the central portion 840 of the fuse and an outer edge of the electrical connection point, the central portion is stabilized and held rigidly in position. For example, when the end/terminal of the cell is pushed down onto the central portion of the fuse, the central portion may move downwards in response to the force applied by the cell, however the central portion 840 will not slip/slide or move sideways (known as “scooting”). Furthermore, when attaching the terminal of the cell to the central portion, it may be attached via a method of ultrasonic welding. The ultrasonic welding may normally also cause the central portion 840 to slip/slide or move sideways. The provision of the fuse arms thus also acts to prevent the lateral movement of the central portion of the fuse during the welding. As a consequence the connection between the cell terminal and the central portion of the fuse is assured.

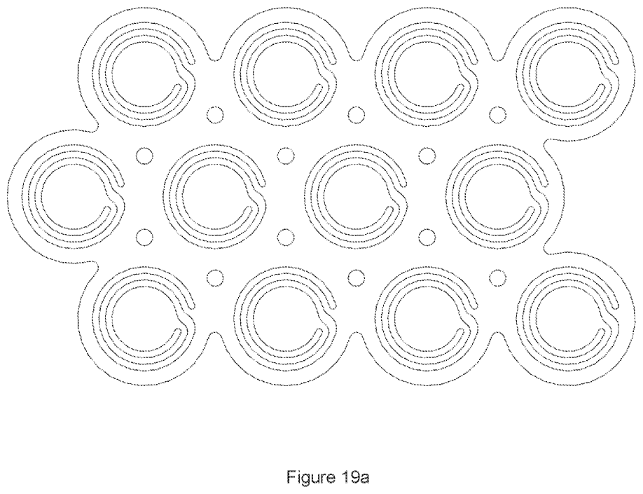

A cross-sectional view of one of the fuses described above is depicted in FIG. 18a. As shown in FIG. 18a the fuse 900′ is formed as part of the electrical end plate 930. There is provided a central portion 940′ of the fuse and three spiral fuse arms 950 which connect the central portion 940′ to the electrical end plate 930. When attaching a cell to the fuse, the terminal of the cell (for example the positive terminal) is attached to the central portion 940′ by, for example, ultrasonic welding. As the cell is attached a force is applied onto the central portion 940′. The spiral fuse arms 950 allow the central portion to move downwards (i.e. down through the page as shown in FIG. 18a), however they will prevent the central portion moving sideways. Section A-A depicts another cross-sectional view of the fuse. See FIG. 18b. As is shown in Section A-A, the fuse arms may be thinner than the central portion and/or the electrical end plate 930.

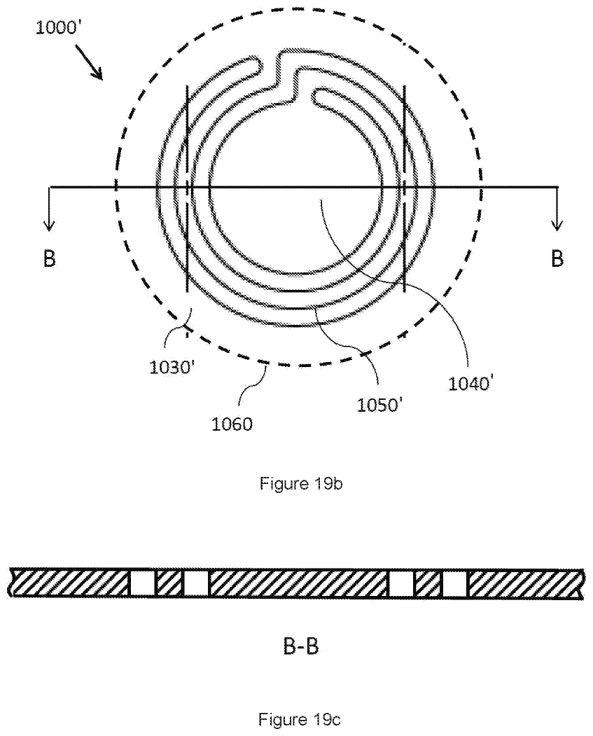

FIGS. 19a, 19b and 19c show an alternative arrangement to that of FIGS. 17, 18a and 18b. All the aforesaid options for the arrangement of those figures apply to the arrangement of FIGS. 19a, 19b and 19c.

In the arrangement of FIGS. 19a, 19b and 19c, each fuse which forms each electrical connection point may have a central portion 1040′ for connection with a positive terminal of a cell, and the central portion may be held in place by one continuous spiral fuse arm 1050′ as depicted in cross-sectional view shown in FIGS. 19a and 19b. The continuous spiral fuse arm 1050′ connects the central portion 1040′ to the electrical end plate 1030′, see FIG. 19c. Because the single fuse arm is longer, it is not necessary that it is made thinner (but it can be). Section B-B depicts another cross-sectional view of the fuse.

The spiral fuse arm is shown as having one complete or almost complete turn. I.e. it has a length that is equivalent to the circumference of the central portion. It may be shorter (e.g. a half-turn) or longer (e.g. one and a half turns to three turns). It preferably comprises a number of full turns.

By providing the single continuous spiral fuse arm 1050′ it is easier to control current at which the fuse blows than if there are multiple fuse arms. The single fuse arm give less rigidity against horizontal scooting, but this need not be a problem if there is no welding required, e.g. if it is connected to the cell by conducting adhesive.

As can be seen from FIGS. 8, 18a, 18b, 19a, 19b and 19c, a new battery fuse arrangement is provided that comprises single sheet of metal, having a fuse formed therein for each cell of a plurality of cells in a battery. The fuses are no thicker than the sheet of metal. The sheet of fuses serves both to connect the cells in parallel and to provide a fuse to each cell. It is a lightweight arrangement. The fuses do not need to extend above or below the sheet. The fuses therefore add no more to the height of the battery than the sheet itself (and any solder or other bonding material by which they bond to the cells). This is highly advantageous when seeking to insert batteries into small spaces in a vehicle or designing a vehicle to be compact and to have a high power-to-weight ratio.

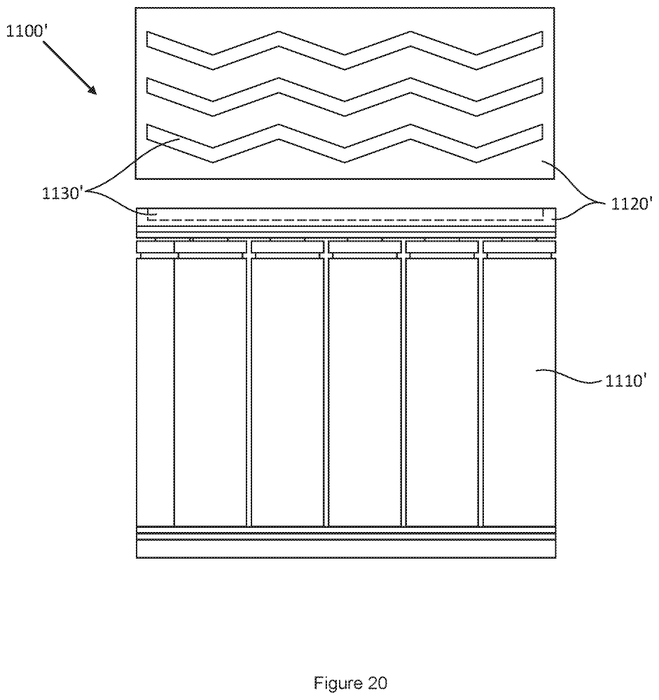

FIG. 20 depicts the top surface of a battery such as that of FIG. 16, save that the top of the battery of FIG. 20 has a plate on it that is configured with at least one channel, and preferably a plurality of channels 1130′ which are configured to allow the flow of a coolant across the plate.

The plate may be an electrical end plate i.e. a first electrical end plate to electrically connect the plurality of cylindrical cells in parallel 1120′. For example, the array of cells 1110′ when formed in the hexagonal pattern depicted in FIG. 20 may be connected together via terminals at the top of each cell via an electrical end plate. I.e., a first electrical end plate electrically connects the plurality of cylindrical cells in parallel 1120′. That first electrical end plate may be configured with at least one channel, and preferably a plurality of channels 1030′ which are configured to allow the flow of a coolant across the first electrical end plate. Alternatively, a separate coolant end plate may be provided which is located adjacent to the first electrical end plate. The separate coolant end plate may have the plurality of channels 1130′ formed into the plate. The channels are configured to allow the flow of a coolant adjacent to/across the first electrical end plate. Where there is a separate coolant end plate provided, there may also be a first electrically insulating membrane sandwiched between the first coolant end plate and the first electrical end plate to electrically insulate the two layers.

Whether the channels are provided in the first electrical end plate or a separate coolant end plate, they are provided to cool the end/the terminal of each cell adjacent to the first electrical end plate. The cooling occurs by passing a coolant, such as a fluid, through the channels to extract heat from the terminal of each cell proximate to the channel. The coolant is preferably not electrically conductive. For example it may be dielectric oil or de-ionised water. Other possible coolant fluids are possible. By allowing the flow of coolant across the top of the battery, proximate to the first electrical end plate, overheating of the cells can be prevented which improves the functionality of the cells and thus the battery as a whole.

Although the provision of coolant is only shown in FIG. 20 with respect to the first electrical end plate, a coolant end plate may also be provided at the other end of the cells i.e. at the bottom of the cells, to provide cooling to the other terminals of the cells also. The provision of the coolant end plate at the other end of the cells may be instead of, or in addition to, the provision of the cooling at the top of the cells as shown in FIG. 20.

There is at least one channel in the electrical end plates, or the coolant end plates are configured to provide a turbulent fluid flow. In turbulent flow, the fluid undergoes irregular fluctuations, or mixing, in contrast to laminar flow, in which the fluid moves in smooth paths or layers. Furthermore, in turbulent flow the speed of the fluid at a point is continuously undergoing changes in both magnitude and direction. Advantageously, swirling and diffusive characteristics of turbulent fluid flow enhances heat transfer. By improving the heat transfer the amount of heat that can be extracted from the cell is increased thereby further ensuring the proper functioning of the battery.

To configure there is at least one channel to provide turbulent fluid flow, the channel may be designed to have a ‘zigzag’ pathway for the fluid as shown in FIG. 20. Other designs are possible to create turbulent fluid flow. For example, any pathway that has sharp edges (for example a vortex generator), or turns to cause a change in the direction of the fluid flow will provide a turbulent fluid flow.

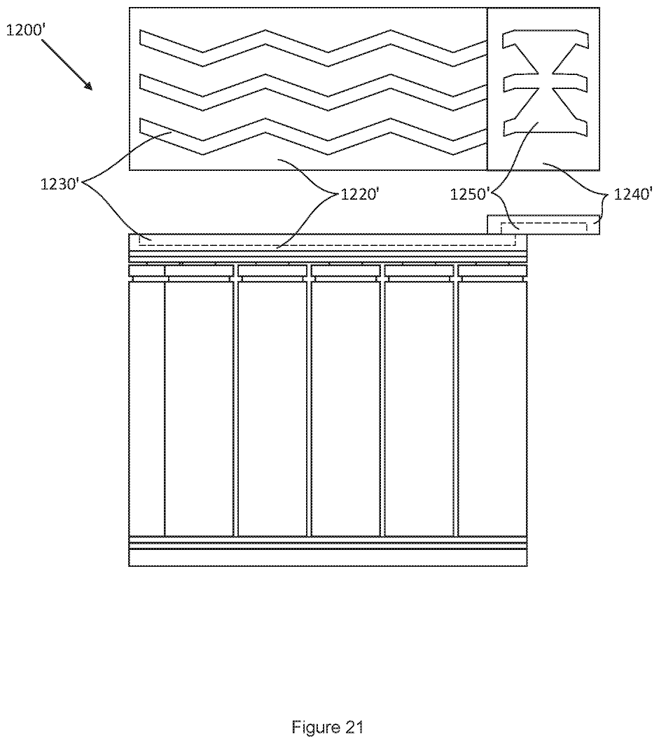

FIG. 21 depicts a top surface of the battery similar to that shown in FIG. 20. In addition to that shown in FIG. 20 there is also an interface plate 1240′ connected to the first coolant end plate 1220′. The interface plate is, in effect, a bus bar. It is made of conductive material and is generally designed to conduct high current, i.e. at least the combined current of all the cells in a battery, i.e. higher current than the current flowing at any mid-section of the electrical end plate. E.g. in the case where there is a separate end plate and coolant end plate, the bus bar is thicker than the end plate. In the case where the channels are formed in the electrical end plate itself, the bus bar may be as thick as or thicker than the electrical end plate or at least thicker than the thinnest part of the electrical end plate.

The interface plate 1240′ has a number of fluid pathways 1250′ which are positioned to connect to the channels 1230′ of the first coolant end plate 1220′ to provide a continuous flow path for coolant between the first coolant end plate 1220′ and the interface plate 1240′. In other words, the fluid pathways 1250′ are in communication with the channels 1230′ of the coolant end plate 1220′.

Once the channels of the coolant end plate of the battery are connected to the interface plate 1240′, an additional battery of the same design may be attached to the same interface plate 1240′ to connect two batteries into a pack (not shown). For example, a second end of each of the fluid pathways 1250′ of the interface plate 1240′ may be connected to be in fluid communication with a respective one of a channel of a coolant end plate of another battery so that coolant can flow across the coolant end plate of a first battery, across the interface plate 1240′, and across a coolant end plate of a second battery. In this way, the coolant used to cool the terminals of a battery can be shared across multiple batteries in a pack and flows in the plane of, and across, the interface plate between coolant end plates of the batteries that are connected together via the interface plate.

In the arrangement shown (which is merely by way of example), there are three fluid pathways 1250′ and each has a first end in fluid communication with a respective one of the channels 1230′ and a second end for connection to an adjacent battery or to an end manifold. For example, in FIG. 21 each of the three channels 1230′ is in fluid communication with a respective fluid pathway of the interface plate 1240′ and the fluid pathways 1250′ join at a central manifold region. It will be understood that other arrangements are possible. For example, there may be a common flow region within the end plate 1220′ into which and out of which all fluid pathways mix and flow. There may be pillars or islands of material around which the coolant flows. The pathways within the coolant end plate 1220′ may join and split. Alternatively, there may be one-to-one connection between a fluid pathway of one battery and a fluid pathway of an adjacent battery.

Similarly, there may be a broad open central region within the interface plate 1240′ for incoming fluid to mix before flowing out.

When attaching the second battery to the interface plate 1240′, the terminals of the cells of the second battery proximate to the interface plate 1240′ may have the opposite polarity to the terminals of the cells of the first battery proximate to the interface plate 1240′ so that they are connected in series. Alternatively the terminals of the cells of the two batteries proximate to the interface plate 1240′ may be of the same polarity so that they are connected in parallel. If the polarities are opposite, an insulator may be provided between the two batteries.

Instead of providing an interface plate 1240′, the coolant used to cool the terminals of a battery may be shared across multiple batteries in a pack by providing a continuous water-proof film that extends across more than one battery. (This may also be referred to as a water proof layer). It may comprise a water proof polyimide film made from e.g. Kapton®.

One such film may be provided on either side of the layer that provides the channel(s). A seal is provided around the periphery of the two films. E.g. a pair of such films can direct coolant flow across the first electrical end plate to cool the first end of each cylindrical cell of the battery.

For example, the first coolant end plate with the channels formed in it may be arranged on top of a first water-proof film, with the film sandwiched between the first electrical end plate and the first coolant end plate.

Alternatively, the first electrical end plate (with or without the channels formed in it) may be arranged on top of the battery such that there is a first water-proof film sandwiched between the top of each cell of the battery and the first electrical end plate. In this case, electrical conduction needs to be provided through the first water-proof film between the cells and the first electrical end plate. This can be done by known printing methods in the manufacture of Kapton and similar waterproof films.

In addition, a second water-proof film is placed on top of the first electrical end plate/first coolant plate (i.e. on an outermost surface of the first electrical end plate/first coolant plate). In this way the component providing the channels (the first electrical end plate or the first coolant plate) is sandwiched between two water-proof films. A seal is provided around the periphery of the two water-proof films.

By sandwiching the first electrical end plate/first coolant plate between the two water-proof films, two batteries may be arranged side by side without an interface plate connecting them, with the coolant flowing across the top of the first electrical end plates/first coolant plate of one battery and then across the top of the first electrical end plates/first coolant plate of the next, adjacent battery. This may continue across more batteries in a row or in a sequence of side-by-side batteries (e.g. in a snake-like pattern).

The two water-proof films prevent the coolant from flowing down through the battery in between the cells of the battery.

Two water-proof films may also be provided either side of the second electrical end plate/second coolant plate, when channels and/or a second coolant end plate are provided at the other end of the cells, instead of, or in addition to, the provision of the cooling at the top of the cells as shown in FIG. 20.

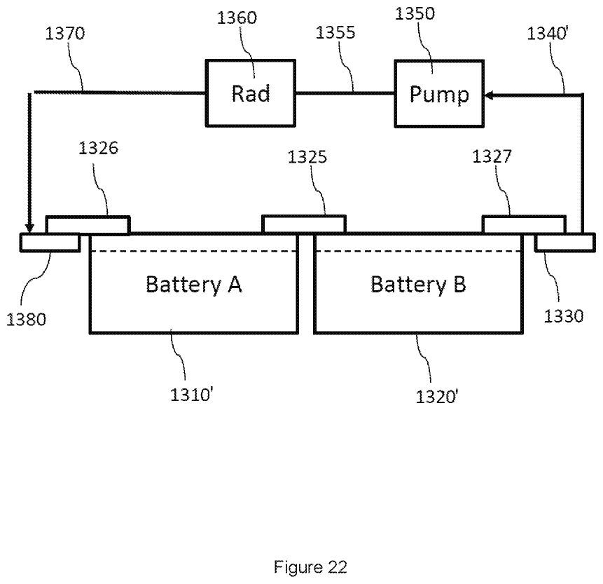

FIG. 22 shows a battery system comprising two batteries, battery A 1310′ and battery B 1320′ with a connecting interface plate 1325 joining the two. A further interface plate 1326 and 1327 is provided at each end of the battery pack. The system also comprises a manifold 1330, a warm pipe 1340′, at least one pump 1350, at least one radiator 1360 and a connecting pipe 1355 connecting the pump(s) to the radiator(s). The pump(s) and radiators(s) can be integrated such that there is no connecting pipe. A cold pipe 1370 connects the radiator 1360 to another manifold 1380 and to the interface plate 1326 to complete a circuit.

Although only two batteries are shown in the system, any number of batteries may be incorporated into the system. The plurality of batteries may be referred to as a battery pack.

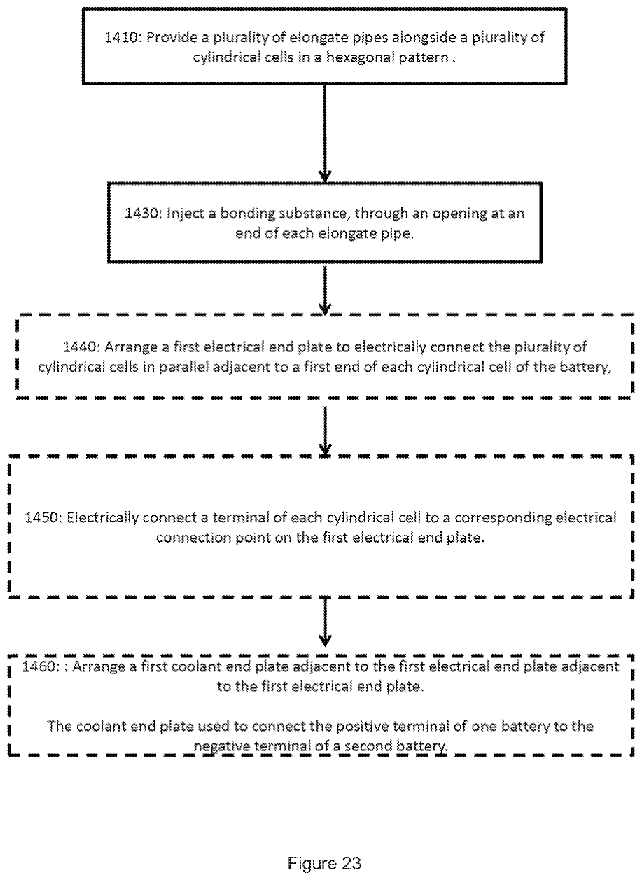

FIG. 23 is flow chart depicting to a method of manufacturing a battery, in particular a battery as depicted in FIGS. 14 & 16.

The method starts at 1410 and involves providing a plurality of elongate pipes for a plurality of cylindrical cells, such that a length of each elongate pipe extends along a length of the cylindrical cell between a negative and a positive terminal of the cylindrical cell. I.e. the elongate pipes extend between first ends and second end of the cells. The pipes may be fitted into holders as previously described and the cells added, or the pipes may be arranged in the gaps between cells using a suitable jig to hold them in place.

The elongate pipes may be triangular pipes as shown in FIG. 15. Each elongate pipe also has a plurality of openings along a length of the elongate pipe adjacent to the outer surface of the cylindrical cell, when the pipe is attached to the cell.

The plurality of cylindrical cells is arranged into a hexagonal pattern such as the pattern shown in FIGS. 6, 8 & 16. Once in the hexagonal pattern the openings along the length of each elongate pipe attached to each cell are such that they are in abutment with an adjacent outer surface of an adjacent cylindrical cell.

At 1430 a bonding substance or material, such as an epoxy resin, is injected, through an opening at an end of each elongate pipe under pressure such that the bonding substance flows along the length of each elongate pipe and oozes out of the openings along the length of each elongate pipe. The bonding substance may be injected into openings at the top of elongate pipes or the bottom of each elongate pipe. Alternatively, the bonding substance may be injected into the bottom ends of the elongate pipes. Depending on the size of the opening through which the bonding material is to be injected, it may be injected using a nozzle that is inserted into the opening.

By injecting the bonding material under pressure, the material is forced through the pipe and out of the holes/openings along the length of the pipe. By the bonding material oozing out of the openings along the length of the elongate pipe, the boding substance or material comes into contact with the outer surface of adjacent cells, and bonds those outer surfaces to the elongate pipe. Optionally, by providing holes/openings close to the base of the elongate pipe, the boding substance or material also comes into contact with the insulators (and the triangular holders when present), also providing bonding at those positions.

By bonding the cells to the triangular support structures (which may be in turn connected to the triangular support structures attached to the insulators when present), the rigidity of the whole battery structure is improved, and hexagonal arrangement of the cells is maintained.

At 1440 a first electrical end plate may be arranged, adjacent to a first end of each cylindrical cell of the battery so at to connect the plurality of cylindrical cells in parallel. For example a first electrical end plate may be arranged adjacent to the negative terminals of the cells in the battery. At least one channel is provided to direct coolant flow across the first electrical end plate to cool the first end of each cylindrical cell of the battery.

At 1450 a second electrical end plate is arranged adjacent to a second end of each cylindrical cell of the battery. For example a second electrical end plate may be arranged adjacent to the positive terminals of the cells in the battery. Arranging the second electrical end plate may include electrically connecting a positive terminal of each cylindrical cell to a corresponding electrical connection point (i.e. a fuse) on the second electrical end plate, each electrical connection point comprising a central portion for connection with the terminal of the cylindrical cell and at least two fuse arms extending between the central portion and an outer edge of the electrical connection point. The electrical connection points each comprising a central portion for connection with the terminal of the cell and at least two fuse arms being as shown in FIGS. 17 & 18.

Connecting a terminal of each cell to a corresponding electrical connection point on the second electrical end plate may include connecting them together via ultrasonic welding techniques. Ultrasonic welding is a solid-state welding process in which joining of materials (metals and plastics) occur without melting. In ultrasonic welding, high-frequency mechanical vibrations are transferred to the parts to be joined, which cause sliding of one part over another. The joining occurs as a result of heat generated by friction and severe plastic deformation.

The fuse arms and central portions of the second electrical end plate may be pre-formed by an etching process. For example, the second electrical end plate may be etched to form the fuse arms and the central portions of the fuse on the electrical end plate. The fuses may be pre-etched onto the electrical end plate such that the fuse arms and the central portion have the same thickness. Alternatively, the fuse arms may be thinner than the central portion. In addition the fuse arms may be thinner than the rest of the electrical end plate i.e. they may be thinner than an outer edge of the electrical connection point.

At 1460 battery packs are created by connecting modules in series. A coolant endplate is used to connect the positive terminal of one module to the negative terminal of the second module. The coolant endplate incorporates cooling channels. a first coolant end plate may be arranged adjacent to the first electrical end plate (where the first coolant end plate and the first electrical end plate are separate plates). The first coolant end plate has the at least one channel to direct coolant flow across the first coolant end plate to cool the first end of each cylindrical cell of the battery. In addition, when a first coolant end plate is provided, it may be necessary to provide electrical insulation, such as an electrically insulating membrane, between the first electrical end plate and the first coolant end plate. Alternatively, a first coolant end plate may not be needed, as the first electrical end plate may be configured to have the at least one channel through which coolant can flow. When the first electrical end plate also acts as a coolant end plate, the electrical end plate may need to be designed to provide insulation between the electrical conducting side of the plate and the coolant flow side of the plate. Advantageously, by providing a first electrical end plate that also doubles up as a coolant plate, the number of components in the battery is reduced.

Additionally, or alternatively a first coolant end plate (or a second coolant end plate if in addition to the first coolant end plate) may be arranged adjacent to the second electrical end plate. Such a coolant end plate is the same as the first coolant end plate described above. Similarly to that described above, instead of providing a separate coolant plate adjacent to the second electrical end plate, the second electrical end plate itself may be configured with channels on one side of it to allow the flow of coolant across it. Advantageously, by providing multiple coolant plates, overheating of the battery is preventing more effectively.

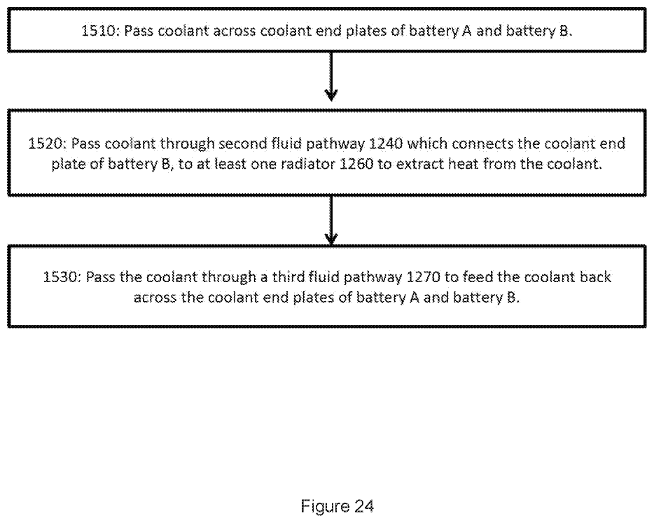

FIG. 24 depicts flow chart relating to a method of operating the battery system of FIG. 22. During operation at 1510 coolant flows across the coolant end plate of battery A 1310′, across the interface plate 1325, and then across the coolant end plate of battery B 1320′. The interface plates 1326, 1380, 1327, and 1330 are shown to emphasize that the system may contain many more than two batteries and battery A & B are only shown as examples. The coolant end plates atop of the batteries are the same as those shown in FIGS. 20 & 21. The interface plates are the same as those shown in FIG. 22. Once it has passed across the coolant end plates of all the batteries in the system it then passes, at 1520, to a second fluid pathway 1340′ which connects the coolant end plate of the last battery in the system i.e. battery B 1320′ in this case, to at least one radiator 1360. The coolant then passes through the radiator. The radiator may be any type of heat exchanger that is capable of extracting heat from the coolant, the extracted heat being the heat that the coolant has previously extracted from the batteries in the system. There may also be a pump 1350 located between the battery B 1320′ and the radiator 1360, splitting the second fluid pathway into two portions 1340′ and 1355. The pump 1350 acts to pump the coolant into the radiator.

Once the coolant has been passed through the radiator/heat exchanger, the coolant is passed, at 1530, through a third fluid pathway 1370 which feeds the coolant back to battery A 1310′ and thus back across the coolant end plates of the batteries in the system. Additionally there may also be pump (not shown) between the radiator 1360 and the battery A 1310′ to pump the coolant from the radiator back to the battery pack.

As has been explained, the bonding material between the cells is structural, in the sense that it adds rigidity to the overall structure.

The cylindrical cells may be held within a cuboidal container that is mechanically fixed to the vehicle body (e.g. by epoxy resin and/or reinforcing fiber or by a suitable surrounding flange that is glued/welded/bolted or otherwise rigidly fixed to the vehicle.

Referring to FIG. 2, the space between the layers 250 and 260 would be an area of interest for containing batteries contributing to the overall rigidity and structural integrity of the vehicle. The batteries take the place of filler material that would otherwise fill the space between the layers, thereby providing rigidity against bending and shearing as well as protection against compression forces that might cause the panels to buckle. The space between the front and rear (fore and aft) layers 270, 280 of the rear bulkhead are another suitable location, giving the bulkhead rigidity. Batteries can occupy space that would otherwise be occupied by the fuel tank 210 or by rib spars and other structural components. This is advantageous because it increases the energy and power density of the battery pack by removing existing structure and replacing it with structural batteries. Or put another way, reduces the overall weight of the structure.

When containing cells within a battery container, the container is preferably cuboidal in shape, but any shape that fit all the cells would suffice. The outermost cells of the battery are preferably rigidly fixed to the inside of the battery container. This fixing can be done with a similar bonding material to the bonding material used to bond cells together, or any other bonding material.

The battery container should thus be similar in size to the battery in order to facilitate a rigid fixing of the battery to the battery container. The size of the battery container should allow for some room above and/or below the battery to take into account the coolant system (if provided).

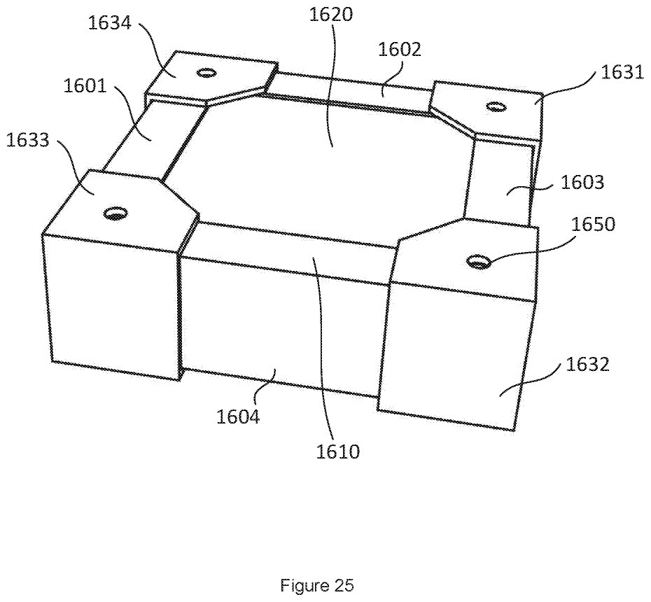

A first example of a cuboidal container is shown in FIG. 25. It is approximately square but can be rectangular or trapezoidal or have other shapes. It has four walls 1601, 1602, 1603 and 1604, made, for example, from metal and each bent or extruded into a C-shaped cross section. Plastics material (reinforced or not) is an alternative to metal. Each wall has an upper flange and a lower flange (e.g. upper flange 1610). There is a lid 1620, a similar floor (not shown) and four corner brackets 1631, 1632, 1633, 1634, each having an upper hole 1650 and a lower hole (not shown) for bolting to the body of a vehicle. The lid and floor may be end plates previously described or may be additional to those end plates.

The upper flanges and lower flanges of the walls 1601, 1602, 1603 and 1604 are spaced to accommodate a battery pack—i.e. the length of a battery cell plus the lid 1620, the floor and uppermost and lowermost end plates with all fuses and cooling channels therein. These may form a snug interference fit or a fit with a small tolerance or a fit with sufficient space to allow a layer of bonding material to bond between the lid and the uppermost end plate and/or between the lowermost end plate and the floor. The corner brackets similarly fit tightly to or are bonded to the walls and are bolted, welded or bonded to the vehicle. The entire structure is compact and very strong and rigid.

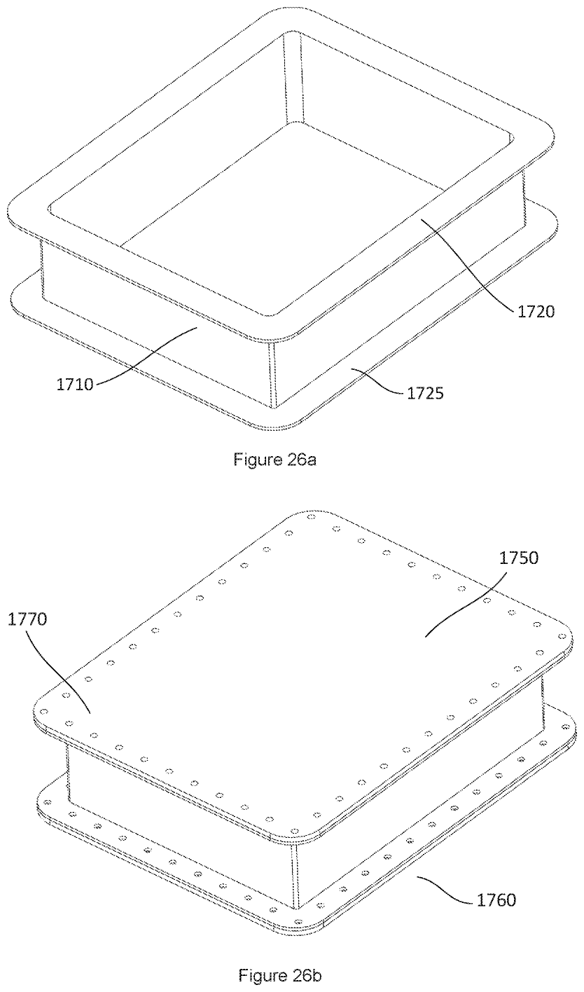

An alternative structure is shown in FIGS. 26a and 26b. The container has a singular C-section wall 1710 created as a single piece. In this case, the C-section is reversed in that the centre wall is innermost and there are upper and lower flanges 1720 and 1725 that extend outwards. As shown in FIG. 26b, a top plate 1750 and a bottom plate 1760 are attached to the top and bottom respectively to create a double-layer surrounding flange. A series of holes may be formed all the way around (or at selected locations around) this flange. The double-layer flange may be formed and then drilled with holes, or the holes may be pre-formed in the respective components so that through-holes are provided when the top plate and bottom plate are added.

The arrangement of FIG. 26b has a number of advantages. In summary it can transmit the mechanical load from the structure to the battery pack more efficiently and without introducing stress concentration points at four corner positions as seen in FIG. 25, 1650. It is easier to manufacture and can be constructed from bottom to top, without the need to apply horizontal force to place the battery in the container. Thus, there is no side-shear on the batteries, fuses and cooling arrangements during construction. It is easy to apply bonding material beneath and above the batteries. It can provide better bonding between cells and top plate and between top plate and flanges. If there is any gap between the top plate and flange of the C-section side wall, this can be sealed by bonding material and made watertight.

The provision of outward-facing flanges allows flexibility as to fixing points. It is not limited to having bolts in corner brackets. Neither is it limited to having connection points that coincide with cells or gaps between cells. It can provide for more holes and therefore greater distribution of load.

Any of the batteries described may be mounted in the hull of a boat, watercraft, or ship having an inner layer and outer layer with a space between these layers where the batteries may be fixed. The cells of the batteries may be located in a radial direction, i.e. with the axial dimension of the cells mounted normal to the hull, i.e. “vertically” with inner and outer electrical plates attached on the positive and negative terminals. However, the cells can be arranged “horizontally”. In this arrangement, the cells lie parallel to the inner and outer layers and each electrical end plate extends in an annulus around the vehicle. This configuration works very well for circular or curved requirements such as aircraft hulls. Indeed, the individual cells are more resistive to radial compression than axial compression and, with adhesive between them to stop them rolling against each other, the construction is very strong.

Batteries so positioned contribute to/increase the overall rigidity and structural integrity of a boat. Lower positions and close to the keel are preferred for stability, but higher locations may be preferred for protection against impact forces in areas that may be vulnerable to collision. Batteries of equal weight are preferably positioned in pairs on port and starboard sides, at equal distance from the centerline of the boat.

Batteries may be mounted in an aerofoil or wing of an aircraft. The batteries may run substantially most of the length along an aircraft wing, from the fuselage to almost the tip, In this way, the batteries can serve as a beam to contribute to the overall rigidity and structural integrity of the wing. With such batteries, other internal reinforcing structures can be omitted. For example, there may be stringers forward and rearward of the batteries but none in the vicinity of the batteries. Equally, there need not be a reinforcing web where the batteries extend. In this way structural components are replaced by batteries, which also serve the same structural purpose as the structure replaced.

An aircraft cabin may be a monocoque structure with an outer skin and an inner skin. Batteries may be located therebetween to contribute to the overall rigidity and structural integrity of any structures in this space, as well as to the cabin. If the cells are placed in the “horizontal” orientations, the cells can fit in the space between the inner and outer skins of the fuselage without any need to re-design or alter the shape.

As another example we may consider a monocoque fuselage of a helicopter or eVTOL craft. It may have a nose, a tail, a forward floor panel, a mid floor panel and a rear floor panel. It may have upper ribs and lower ribs. A reinforcing rib may also be present and integral to the rear floor panel. This is optional. All the aforesaid elements are integrally constructed as a monocoque structure. Each of the floor panels may be constructed of inner and outer layers (skins) with filler material therebetween. The filler material may have voids throughout. The entire construction is strong and lightweight and has good crash resistance. A reinforcing rib may be used as a location for batteries. Alternatively, where the batteries are located between the layers of the monocoque structure, such a rib may be unnecessary. Batteries are preferably located in the floor behind (rearward of) the occupants (pilot, co-pilot, passenger) and/or beneath the occupants.

The present invention is not limited to the above examples only, and other examples will be readily apparent to one of ordinary skill in the art without departing from the scope of the appended claims. These and other features of the present invention have been described above purely by way of example. Modifications in detail may be made to the invention within the scope of the claims.

1. A vehicle comprising
a. a body having first and second layers that form at least part of a monocoque structure;
b. a battery comprising cylindrical cells held together by a bonding material in a hexagonal pattern in a same plane, bonding a surface of a cell to an adjacent surface of an adjacent cell with triangular gaps between the cells, wherein the battery is located between the first and second layers; and
c. wherein the cylindrical cells are held within a cuboidal container that is mechanically fixed, glued or welded to the first and second layers of the body by a surrounding flange that is rigidly fixed to the body.

2. (canceled)

3. The vehicle of claim 1 wherein the surrounding flange is mechanically fixed to the first and second layers of the body, wherein the surrounding flange is bolted or riveted to the vehicle body.

4. (canceled)

5. The vehicle of claim 1 wherein one of the first and second layers is an outer skin of the vehicle.

6. The vehicle of claim 5, wherein the battery has a positive terminal and a negative terminal and the negative terminal is electrically connected to the outer skin.

7. The vehicle of claim 1, wherein the vehicle is an automobile, motorbike, scooter, e-mobility platform, watercraft, submarine, eVTOL helicopter or aircraft.

8. A method of manufacturing a vehicle comprising providing a plurality of cylindrical cells and bonding surfaces of the cells to adjacent surfaces of adjacent cells in a hexagonal pattern in a same plane, with triangular gaps between the cells to form a battery, wherein the cylindrical cells are held within a cuboidal container, manufacturing a vehicle comprising a body having first and second layers that form at least part of a monocoque structure;
a. placing the cuboidal container holding the cylindrical cells between the first and second layers; and
b. mechanically fixing, gluing or welding the cuboidal container to the first and second layers of the body by a surrounding flange that is rigidly fixed to the body.

9. The method of manufacture of claim 8, wherein the mechanically fixing is one of bolting and riveting.

10. A battery comprising a plurality of cylindrical cells held together by a bonding material in a hexagonal pattern in a same plane, bonding a surface of a cell to an adjacent surface of an adjacent cell with triangular gaps formed therebetween, and
wherein a first end of each cylindrical cell of the battery is connected to a first electrical end plate to electrically connect the plurality of cylindrical cells in parallel,
wherein at least one channel is provided to direct coolant flow across the first electrical end plate to cool the first end of each cylindrical cell of the battery,
wherein the cylindrical cells are arranged within a cuboidal container, and wherein the cuboidal container comprises at least one surrounding flange for rigidly fixing the cuboidal container to first and second layers of a monocoque structure of a vehicle.

11. The battery of claim 10 further comprising:
a first coolant end plate adjacent to the first electrical end plate, the at least one channel being formed in the first coolant end plate.

12. The battery of claim 11 further comprising:
a first electrically insulating membrane sandwiched between the first electrical end plate and the first coolant end plate.

13. The battery of claim 10, wherein the at least one channel is configured to create turbulent flow of coolant therein.

14. The battery of claim 10, wherein the at least one channel has at least one sharp edge.

15. The battery of claim 10, wherein the at least one channel has a zigzag form.

16. (canceled)

17. (canceled)

18. The battery of claim 10, wherein a second end of each cylindrical cell of the battery is connected to a second electrical end plate.

19. The battery of claim 18, wherein at least one channel is provided to direct coolant flow across the second electrical end plate to cool the second end of each cylindrical cell of the battery.

20. The battery of claim 19 further comprising:
a second coolant end plate adjacent to the second electrical end plate, the at least one channel being formed in the second coolant end plate.

21. The battery of claim 10 further comprising:
a first and a second water-proof layer either side of the at least one channel respectively, and configured to prevent coolant flowing through the triangular gaps formed between the adjacent cells.

22. A battery pack comprising:
a first battery in combination with a second battery, each battery according to claim 10;
an interface plate to connect the at least one channel provided to direct coolant flow across the first electrical end plate of the first battery with the at least one channel provided to direct coolant flow across the first electrical end plate of the second battery, wherein the interface plate comprises at least one fluid path for the flow of coolant between the first and second battery respectively, the at least one fluid path having:
a first end in fluid communication with the at least one channel of the first battery, and
a second end in fluid communication with the at least one channel of the second battery.

23. The battery pack of claim 22, wherein the interface plate connects the at least one channel to direct coolant flow across the first electrical end plate of the first battery with the at least one channel to direct coolant flow across the first electrical end plate of the second battery.

24. A battery pack comprising:
a first battery in combination with a second battery, each battery according to claim 18 further comprising:
a second interface plate to connect at least one channel provided to direct coolant flow across the second electrical end plate of the first battery with the at least one channel provided to direct coolant flow across the second electrical end plate of the second battery, wherein the second interface plate comprises at least one fluid path for the flow of coolant between the first and second battery respectively, the at least one fluid path having
a first end in fluid communication with the at least one channel of the first battery, and
a second end in fluid communication with the at least one channel of the second.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)
